(19) United States
(12) Patent Application Publication
(10) Pub. No.: US 2025/0329298 A1
(43) Pub. Date: Oct. 23, 2025

(54) IMAGE DISPLAY APPARATUS

(71) Applicant: LG ELECTRONICS INC., Seoul (KR)

(72) Inventors: Hongkyu SHIN, Seoul (KR); Wonjin LEE, Seoul (KR)

(73) Assignee: LG ELECTRONICS INC., Seoul (KR)

(21) Appl. No.: 19/039,574

(22) Filed: Jan. 28, 2025

(30) Foreign Application Priority Data
Apr. 23, 2024 (KR) 10-2024-0054091

(51) Int. Cl. G09G 3/3258

(52) U.S. Cl. CPC G09G 3/3258; G09G 2320/066; G09G 2330/021

(57) ABSTRACT

An image display apparatus is disclosed. An image display apparatus according to an embodiment of the present disclosure comprises: a display; a signal processing device configured to perform signal processing of an input image and output an image signal corresponding to an output image to, wherein, in response to an importance level of a first area in the input image being a first level and an importance level of a second area being a second level lower than the first level, the signal processing device is configured to control the average picture level of the output image to be lower than the average picture level of the input image by increasing a contrast ratio of the first area and decreasing a luminance level of the second area. Accordingly, it is possible to improve contrast ratio while reducing power consumption.

### CROSS-REFERENCE TO RELATED APPLICATION(S)

Pursuant to 35 U.S.C. § 119, this application claims the benefit of earlier filing date and right of priority to Korean Application No. 10-2024-0054091, filed on Apr. 23, 2024, the contents of which are all incorporated by reference herein in its entirety.

### BACKGROUND

### 1. Field

The present disclosure relates to an image display apparatus, and more particularly, to an image display apparatus capable of improving contrast ratio while reducing power consumption.

### 2. Description of the Related Art

An image display apparatus is an apparatus that displays images.

Recently, in keeping with the increase in image resolution and the increase in image sharpness, the display resolution or peak luminance of a display in an image display apparatus is increasing.

Incidentally, as the display resolution or peak luminance of a display increases, the consumption of power supplied to the display increases.

In this regard, research on how to reduce power consumption in image display apparatuses is being conducted, especially on how to reduce power consumption by correcting the brightness of image data.

However, this method has the issue of low contrast ratios in images although it reduces power consumption.

### SUMMARY

An object of the present disclosure is to provide an image display apparatus capable of improving contrast ratio while reducing power consumption.

Another object of the present disclosure is to provide an image display apparatus capable of improving contrast ratio while reducing power consumption based on efficient computation.

An exemplary embodiment of the present disclosure provides an image display apparatus comprising: a display; a signal processing device configured to perform signal processing of an input image and output an image signal corresponding to an output image to the display, wherein, in response to an importance level of a first area in the input image being a first level and an importance level of a second area in the input image being a second level lower than the first level, the signal processing device is configured to control the average picture level of the output image to be lower than the average picture level of the input image by increasing a contrast ratio of the first area and decreasing a luminance level of the second area.

The signal processing device may be configured to change amount of increase in the contrast ratio of the first area or amount of decrease in the luminance of the second area based on a target power consumption level.

The signal processing device may be configured to change amount of increase in the contrast ratio of the first area or amount of decrease in the luminance of the second area, based on a proportion of the first area or a proportion of the second area.

The signal processing device may be configured to increase the luminance level of the first area.

In eco mode or in low power consumption mode, the signal processing device may be configured to control the average picture level of the output image to be lower than the average picture level of the input image, by increasing a contrast ratio of the first area and decreasing a luminance level of the second area.

The signal processing device may be configured to control a contrast ratio of the first area to be a higher than a contrast ratio of the second area, and amount of decrease in the luminance of the second area to be greater than amount of decrease in the luminance of the first area.

The signal processing device may be configured to calculate importance levels of a plurality of areas in the input image, based on at least one of the segmentation, depth, light field, or prominence in the input image.

The signal processing device may be configured to calculate importance levels of a plurality of areas in the input image based on the temporal and spatial frequency, optical flow, frame-based calculation, or learning in the input image.

The signal processing device may be configured to analyze a histogram of the input image, based on a contrast ratio parameter and a power consumption reduction parameter for the input image, and set different power consumption reduction parameters for the same contrast ratio parameter.

The signal processing device may be configured to separate between a foreground area and a background area in the input image, and in response to the importance level of the foreground area being the first level and the importance level of the background area in the input image being the second level, control the average picture level of the output image to be lower than the average picture level of the input image by increasing a contrast ratio of the foreground area and decreasing a luminance level of the background area.

The signal processing device may be configured to control amount of decrease in the luminance of the foreground area whose level of importance level in the input image is higher to be lower than amount of decrease in the luminance of the background area.

The signal processing device may be configured to change amount of increase in the contrast ratio of the foreground area or amount of decrease in the luminance of the background area, based on a proportion of the foreground area or a proportion of the background area.

The signal processing device may be configured to increase the luminance level of the foreground area.

In eco mode or in low power consumption mode, the signal processing device may be configured to control the average picture level of the output image to be lower than the average picture level of the input image, by increasing a contrast ratio of the foreground area and decreasing a luminance level of the background area.

The signal processing device may be configured to separate between a far area and a near area in the input image, and in response to the importance level of the near area being the first level and the importance level of the far area in the input image being the second level, control the average picture level of the output image to be lower than the average picture level of the input image by increasing a contrast ratio of the near area and decreasing a luminance level of the far area.

The signal processing device may be configured to separate between an in-focus area and an out-of-focus area in the input image, and in response to the importance level of the in-focus area being the first level and the importance level of the out-of-focus area in the input image being the second level, control the average picture level of the output image to be lower than the average picture level of the input image by increasing a contrast ratio of the in-focus area and decreasing a luminance level of the out-of-focus area.

The signal processing device may be configured to separate between a visually prominent area and a visually sunken area in the input image, and in response to the importance level of the visually prominent area being a first level and the importance level of the visually sunken area in the input image being a second level, may be configured to control the average picture level of the output image to be lower than the average picture level of the input image, by increasing a contrast ratio of the visually prominent area and the decreasing a luminance level of the visually sunken area.

The signal processing device may be configured to increase the contrast ratio of the first area as the first level increases, and decrease the luminance level of the second area as the second level decreases.

The signal processing device may be configured to downscale the input image, perform segmentation based on the downscaled input image, separate between a foreground image and a background image based on the segmentation, and increase the contrast ratio of the separated foreground image and decrease the luminance level of the background image.

Another exemplary embodiment of the present disclosure provides an image display apparatus comprising: a display; a signal processing device configured to perform signal processing of an input image and output an image signal corresponding to an output image to the display, wherein the signal processing device is configured to control the average picture level of the output image to be lower than the average picture level of the input image, separate between a plurality of areas in the input image based on importance level, and in response to the importance level of a first area in the input image being a first level, increase the contrast ratio of the first area.

In response to the importance level of a second area in the input image being a second level lower than the first level, the signal processing device is configured to decrease the luminance level of the second area.

The signal processing device may be configured to calculate importance levels of a plurality of areas in the input image, based on at least one of the segmentation, depth, light field, or prominence in the input image.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an example of an internal block diagram of the image display apparatus;

FIG. 3 is an example of an internal block diagram of a signal processing device of FIG. 2;

FIG. 4A is a diagram showing a method of controlling a remote controller of FIG. 2;

FIG. 4B is an internal block diagram of the remote controller of FIG. 2;

FIG. 5 is an exemplary internal block diagram of a display of FIG. 2;

FIGS. 6A to 6C are diagrams referred to in the description of a light-emitting panel of FIG. 5;

FIG. 7 is another exemplary internal block diagram of the display of FIG. 2;

FIGS. 8A and 8B are diagrams referred to in the description of the organic light-emitting panel of FIG. 7;

FIGS. 9A to 9G are views referred to in the description of an operation of an image display apparatus related to the present disclosure.

FIG. 10 is a sequential chart showing a method of operating an image display apparatus according to an embodiment of the present disclosure;

FIG. 11 is an exemplary internal block diagram of a signal processing device according to an embodiment of the present disclosure; and

FIGS. 12A to 15B are diagrams referred to in the description of FIG. 10 or FIG. 11.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

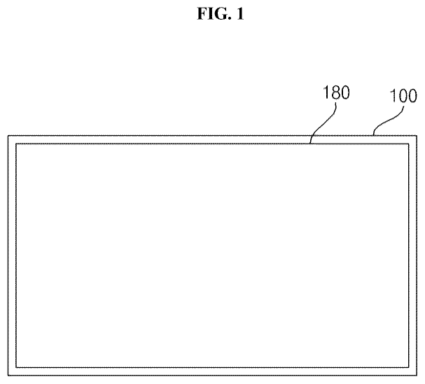

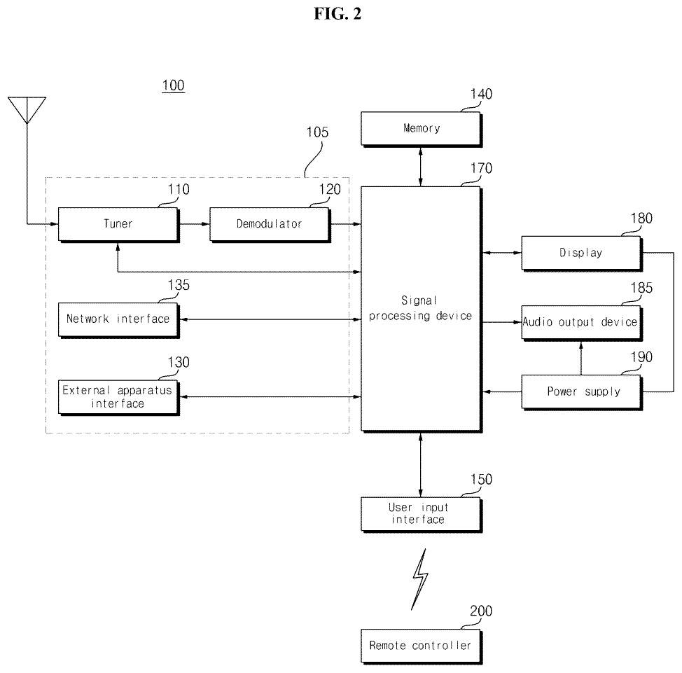

FIG. 1 is a diagram showing an image display apparatus according to an embodiment of the present disclosure.

Referring to the figure, an image display apparatus 100 may include a display 180.

The display resolution of the display 180 is getting higher and higher, and the peak luminance of the display 180 is also increasing. Accordingly, the consumption of power supplied to the display 180 increases.

Meanwhile, the display 180 may be implemented by one of various panels. For example, the display 180 may be a self-luminous display panel, which may be one of an organic light-emitting panel (OLED panel), an inorganic light-emitting panel (LED panel), etc.

An image display apparatus 100 according to an embodiment of the present disclosure proposes a method of improving contrast ratio while reducing power consumption, in a self-luminous display 180.

To this end, the image display apparatus according to an embodiment of the present disclosure comprises a display 180 and a signal processing device (170 of FIG. 2) for outputting an image signal to the display 180.

Meanwhile, if the importance level of a first area in an input image is a first level and the importance level of a second area in the input image is a second level lower than the first level, the signal processing device 170 according to an embodiment of the present disclosure controls the average picture level of an output image to be lower than the average picture level of the input image, by increasing a contrast ratio of the first area and decreasing a luminance level of the second area. Accordingly, it is possible to improve contrast ratio while reducing power consumption. Notably, it is possible to improve the contrast ratio of the first area while reducing the power consumption of the input image.

On the other hand, the signal processing device 170 according to another embodiment of the present disclosure control the average picture level of the output image to be lower than the average picture level of the input image, separate between a plurality of areas in the input image based on importance level, and if the importance level of the first area in the input image is the first level or higher, increases the contrast ratio of the first area. Accordingly, it is possible to improve contrast ratio while reducing power consumption. Notably, it is possible to improve the contrast ratio of the first area while reducing the power consumption of the input image.

Meanwhile, the image display apparatus 100 of FIG. 1 may be a TV, a monitor, a tablet PC, a mobile terminal, or the like.

FIG. 2 is an example of an internal block diagram of the image display apparatus of FIG. 1.

Referring to FIG. 2, the image display apparatus 100 according to an embodiment of the present disclosure comprises an image receiver 105, an external apparatus interface 130, a memory 140, a user input interface 150, a sensor device (not shown), a signal processing device 170, a display 180, and an audio output device 185.

The image receiver 105 may include a tuner 110, a demodulator 120, a network interface 135, and an external apparatus interface 130.

Meanwhile, unlike the figure, the image receiver 105 may include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, if the selected RF broadcast signal is a digital broadcast signal, the tuner 110 converts the digital broadcast signal into a digital IF (DIF) signal and, if the selected RF broadcast signal is an analog broadcast signal, the tuner 110 converts the analog broadcast signal into an analog baseband image or voice (CVBS/SIF) signal. That is, the tuner 110 may process a digital broadcast signal or an analog broadcast signal. The analog baseband image or voice (CVBS/SIF) signal output from the tuner 110 may be directly input to the signal processing device 170.

Meanwhile, the tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and outputs audio to the audio output device 185.

The external apparatus interface 130 may transmit or receive data with a connected external apparatus (not shown), e.g., a set-top box 50. To this end, the external apparatus interface 130 may include an A/V input and output device (not shown).

The external apparatus interface 130 may be connected in wired or wirelessly to an external apparatus, such as a digital versatile disk (DVD), a Blu ray, a game equipment, a camera, a camcorder, a computer (note book), and a set-top box, and may perform an input/output operation with an external apparatus.

The A/V input and output device may receive image and audio signals from an external apparatus. Meanwhile, a wireless transceiver (not shown) may perform short-range wireless communication with other electronic apparatus.

Through the wireless transceiver (not shown), the external apparatus interface 130 may exchange data with an adjacent mobile terminal 600. In particular, in a mirroring mode, the external apparatus interface 130 may receive device information, executed application information, application image, and the like from the mobile terminal 600.

The network interface 135 provides an interface for connecting the image display apparatus 100 to a wired/wireless network including the Internet network. For example, the network interface 135 may receive, via the network, content or data provided by the Internet, a content provider, or a network operator.

Meanwhile, the network interface 135 may include a wireless transceiver (not shown).

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The user input interface 150 transmits a signal input by the user to the signal processing device 170 or transmits a signal from the signal processing device 170 to the user.

For example, it may transmit/receive a user input signal, such as power on/off, channel selection, screen setting, etc., from a remote controller 200, may transfer a user input signal input from a local key (not shown), such as a power key, a channel key, a volume key, a set value, etc., to the signal processing device 170, may transfer a user input signal input from a sensor device (not shown) that senses a user's gesture to the signal processing device 170, or may transmit a signal from the signal processing device 170 to the sensor device (not shown).

The signal processing device 170 may demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

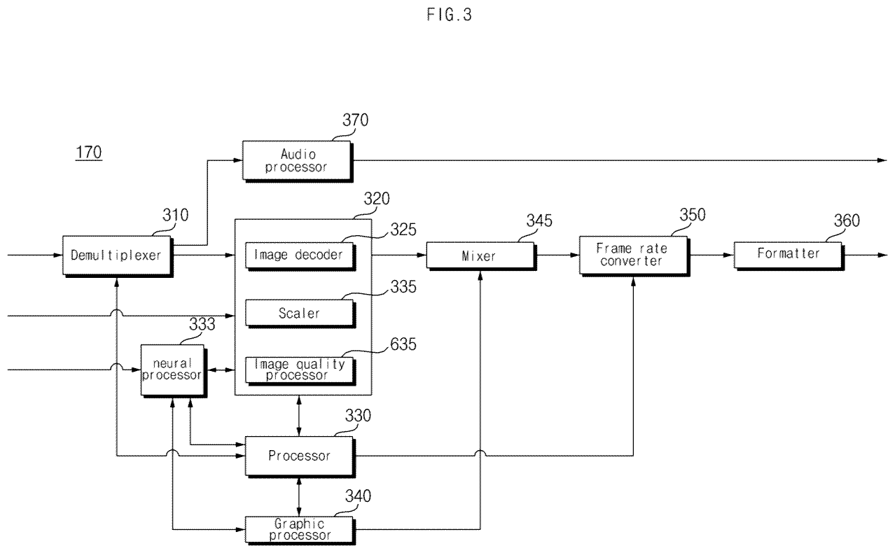

Although not shown in FIG. 2, the signal processing device 170 may include a demultiplexer, an image processor, and the like. That is, the signal processing device 170 may perform a variety of signal processing and thus it may be implemented in the form of a system on chip (SOC). This will be described later with reference to FIG. 3.

In addition, the signal processing device 170 may be configured to control the overall operation of the image display apparatus 100. For example, the signal processing device 170 may be configured to control the tuner 110 to control the tuning of the RF broadcast corresponding to the channel selected by the user or the previously stored channel.

In addition, the signal processing device 170 may be configured to control the image display apparatus 100 according to a user command input through the user input interface 150 or an internal program.

Meanwhile, the signal processing device 170 may be configured to control the display 180 to display an image. At this time, the image displayed on the display 180 may be a still image or a moving image, and may be a 2D image or a 3D image.

Meanwhile, the signal processing device 170 may display a certain object in an image displayed on the display 180. For example, the object may be at least one of a connected web screen (newspaper, magazine, etc.), an electronic program guide (EPG), various menus, a widget, an icon, a still image, a moving image, and a text.

Meanwhile, the signal processing device 170 may recognize the position of the user based on the image photographed by a photographing device (not shown). For example, the distance (z-axis coordinate) between a user and the image display apparatus 100 may be determined. In addition, the x-axis coordinate and the y-axis coordinate in the display 180 corresponding to a user position may be determined.

The display 180 generates a driving signal by converting an image signal, a data signal, an OSD signal, a control signal processed by the signal processing device 170, an image signal, a data signal, a control signal, and the like received from the external apparatus interface 130.

Meanwhile, the display 180 may be configured as a touch screen and used as an input device in addition to an output device.

The audio output device 185 receives a signal processed by the signal processing device 170 and outputs it as an audio.

The photographing device (not shown) photographs a user. The photographing device (not shown) may be implemented by a single camera, but the present disclosure is not limited thereto and may be implemented by a plurality of cameras. Image information photographed by the photographing device (not shown) may be input to the signal processing device 170.

The signal processing device 170 may sense a gesture of the user based on each of the images photographed by the photographing device (not shown), the signals detected from the sensor device (not shown), or a combination thereof.

The power supply 190 supplies corresponding power to the image display apparatus 100.

Particularly, the power may be supplied to a signal processing device 170 which may be implemented in the form of a system on chip (SOC), a display 180 for displaying an image, and an audio output device 185 for outputting an audio.

Specifically, the power supply 190 may include a converter for converting the level of an input voltage.

For example, the power supply 190 may include an ac/dc converter and a dc/dc converter if the input voltage is an alternating current voltage.

As another example, the power supply 190 may include a dc/dc converter if the input voltage is a direct current voltage.

Meanwhile, the power supply 190 may include a battery BTA.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may receive the image, audio, or data signal output from the user input interface 150, and display it on the remote controller 200 or output it as an audio.

Meanwhile, the image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure may include a demultiplexer 310, an image processor 320, a processor 330, and an audio processor 370. In addition, the signal processing device 170 may further include and a data processor (not shown).

The demultiplexer 310 demultiplexes the input stream. For example, when an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may perform signal processing on an input image. For example, the image processor 320 may perform image processing on an image signal demultiplexed by the demultiplexer 310.

To this end, the image processor 320 may include an image decoder 325, a scaler 335, an image quality processor 635, an image encoder (not shown), an Graphic processor 340, a frame rate converter 350, a formatter 360, etc.

The image decoder 325 decodes a demultiplexed image signal, and the scaler 335 performs scaling so that the resolution of the decoded image signal may be output from the display 180.

The image decoder 325 may include a decoder of various standards. For example, a 3D image decoder for MPEG-2, H.264 decoder, a color image, and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may perform image quality processing on an input image signal decoded by the image decoder 325 or the like.

For example, the image quality processor 635 may perform noise reduction processing on an input image signal, extend the high grayscale resolution of the input image signal, perform image resolution enhancement, perform high dynamic range (HDR)-based signal processing, vary frame rates, and perform image quality processing suitable for properties of a panel.

The graphic processor 340 generates an OSD signal according to a user input or by itself. For example, based on a user input signal, the Graphic processor 340 may generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the Graphic processor 340 may generate a pointer that may be displayed on the display, based on a pointing signal input from the remote controller 200. In particular, such a pointer may be generated by a pointing signal processing device, and the Graphic processor 340 may include such a pointing signal processing device (not shown). Obviously, the pointing signal processing device (not shown) may be provided separately from the Graphic processor 340.

The frame rate converter (FRC) 350 may convert a frame rate of an input image. Meanwhile, the frame rate converter 350 may output the input image without converting the frame rate.

Meanwhile, the formatter 360 may change a format of an input image signal into a format suitable for displaying the image signal on a display and output the image signal in the changed format.

In particular, the formatter 360 may change a format of an image signal to correspond to a display panel.

Further, the formatter 360 may convert the format of an image signal. For example, the formatter 360 may convert the format of a 3D image signal into one of various 3D formats, including a side-by-side format, a top/down format, a frame sequential format, an interlaced format, a checker box format, etc.

The processor 330 may be configured to control overall operations of the image display apparatus 100 or the signal processing device 170.

For example, the processor 330 may be configured to control the tuner 110 to control the tuning of an RF broadcast corresponding to a channel selected by a user or a previously stored channel.

In addition, the processor 330 may be configured to control the image display apparatus 100 according to a user command input through the user input interface 150 or an internal program.

In addition, the processor 330 may transmit data to the network interface 135 or to the external apparatus interface 130.

In addition, the processor 330 may be configured to control the demultiplexer 310, the image processor 320, and the like in the signal processing device 170.

Meanwhile, the audio processor 370 in the signal processing device 170 may perform the audio processing of the demultiplexed audio signal. To this end, the audio processor 370 may include various decoders.

In addition, the audio processor 370 in the signal processing device 170 may process a base, a treble, a volume control, and the like.

The data processor (not shown) in the signal processing device 170 may perform data processing of the demultiplexed data signal. For example, when the demultiplexed data signal is a coded data signal, it may be decoded. The encoded data signal may be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may be provided separately in addition to the image processor 320.

Meanwhile, the signal processing device 170 according to an embodiment of the present disclosure may further include a neural processor 333 for a learning process or the like.

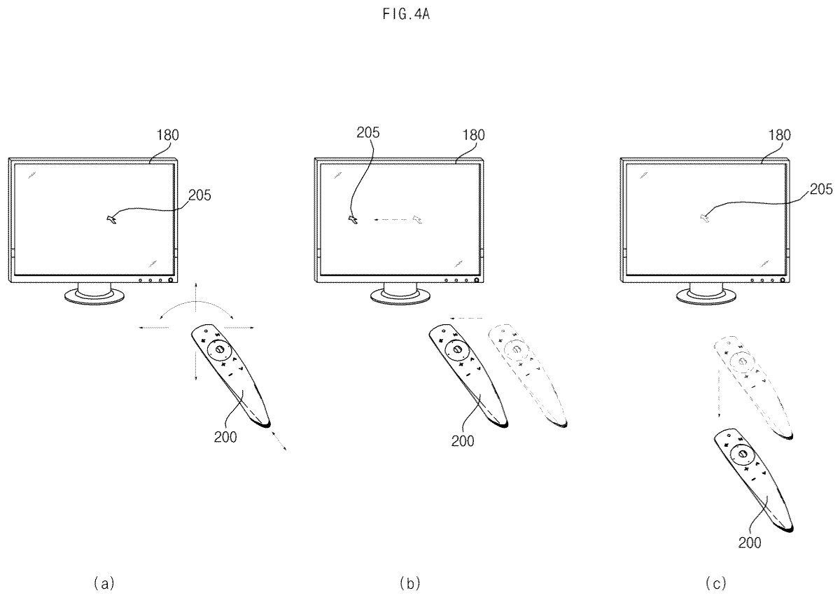

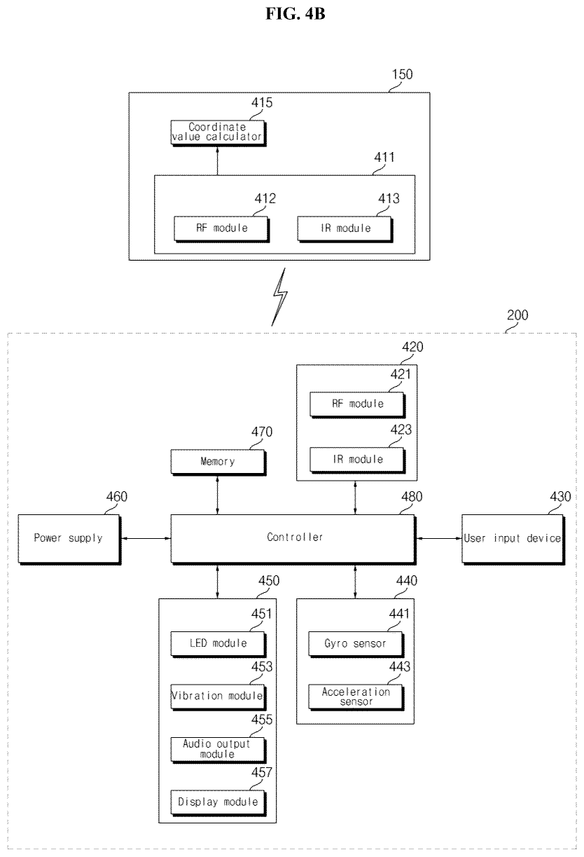

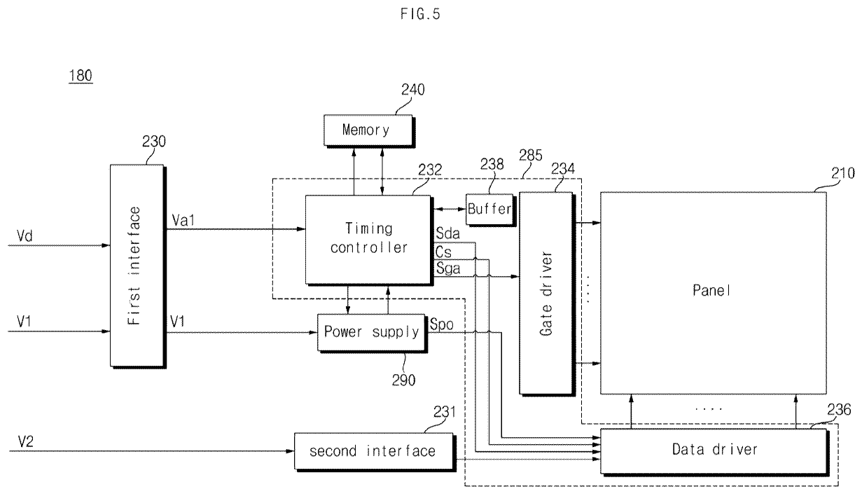

FIG. 4A is a diagram illustrating a control method of a remote controller of FIG. 2.

As shown in FIG. 4A (a), it is illustrated that a pointer 205 corresponding to the remote controller 200 is displayed on the display 180.

The user may move or rotate the remote controller 200 up and down, left and right (FIG. 4A (b)), and back and forth (FIG. 4A (c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A (b) illustrates that when the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A (c) illustrates a case where the user moves the remote controller 200 away from the display 180, while pressing a specific button of the remote controller 200. Thus, a selection area within the display 180 corresponding to the pointer 205 may be zoomed in so that it may be displayed to be enlarged. Meanwhile, when the user moves the remote controller 200 close to the display 180, the selection area within the display 180 corresponding to the pointer 205 may be zoomed out so that it may be displayed to be reduced. Meanwhile, when the remote controller 200 moves away from the display 180, the selection area may be zoomed out, and when the remote controller 200 approaches the display 180, the selection area may be zoomed in.

Meanwhile, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 may correspond to the moving speed or the moving direction of the remote controller 200. FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. When the user input device 435 includes a hard key button, the user may input a command related to the image display apparatus 100 to the remote controller 200 through a push operation of the hard key button. When the user input device 435 includes a touch screen, the user may touch a soft key of the touch screen to input the command related to the image display apparatus 100 to the remote controller 200. In addition, the user input device 435 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on when the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. When the remote controller 200 is not moved for a certain time, the power supply 460 may stop the supply of power to reduce a power waste. The power supply 460 may resume power supply when a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of hand shake or error.

For another example, unlike the figure, the coordinate value calculator 415 may be provided in the signal processing device 170, not in the user input interface 150.

FIG. 5 is an exemplary internal block diagram of a display of FIG. 2.

Referring to the drawing, an LED panel-based display 180 may include a light-emitting panel 210, a first interface 230, a second interface 231, a timing controller 232, a gate driver 234, a data driver 236, a memory 240, a power supply 290, and the like.

The display 180b may receive an image signal Vd, first DC power V1, and second DC power V2, and may display a certain image based on the image signal Vd.

Meanwhile, the first interface 230 in the display 180 may receive the image signal Vd and the first DC power V1 from the signal processing device 170.

Here, the first DC power V1 may be used for the operation of the power supply 290 and the timing controller 232 in the display 180.

Next, the second interface 231 may receive a second DC power V2 from an external power supply 190. Meanwhile, the second DC power V2 may be inputted into the data driver 236 in the display 180.

The timing controller 232 may output a data driving signal Sda and a gate driving signal Sga, based on the image signal Vd.

For example, when the first interface 230 converts the input image signal Vd and outputs the converted image signal Va1, the timing controller 232 may output the data driving signal Sda and the gate driving signal Sga based on the converted image signal Va1.

The timing controller 232 may further receive a control signal, a vertical synchronization signal Vsync, and the like, in addition to the image signal Vd from the signal processing device 170.

In addition to the image signal Vd, based on a control signal, a vertical synchronization signal Vsync, and the like, the timing controller 232 may output a gate driving signal Sga for the operation of the gate driver 234 and a data driving signal Sda for the operation of the data driver 236.

At this time, when the panel 210 includes RGB subpixels, the data driving signal Sda may be a data driving signal for driving the RGB subpixels.

Meanwhile, the timing controller 232 may further output a control signal Cs to the gate driver 234.

The gate driver 234 and the data driver 236 supply a scan signal and a data signal to the light-emitting panel 210 through a gate line GLb and a data line DL, respectively, according to the gate driving signal Sga and the data driving signal Sda from the timing controller 232. Accordingly, the light-emitting panel 210 displays a certain image.

Meanwhile, the light-emitting panel 210 may include a light-emitting layer. In order to display an image, a plurality of gate lines GL and data lines DL may be disposed in a matrix form in each pixel corresponding to the light-emitting layer.

Meanwhile, the gate lines GL may be referred to as scan lines since they receive a scan signal.

Meanwhile, the data driver 236 may output a data signal to the light-emitting panel 210 based on the second DC power V2 from the second interface 231.

The power supply 290 may supply various types of power to the gate driver 234, the data driver 236, the timing controller 232, and the like.

Meanwhile, the timing controller 232, the gate driver 234, and the data driver 236 which are shown in the drawing may be implemented as one integrated circuit IC.

Accordingly, the timing controller 232, the gate driver 234, and the data driver 236 may be referred to as a driving controller 285.

Meanwhile, the driving controller 285 may include a buffer 238 that stores frame data.

In particular, the timing controller 232 in the driving controller 285 may output gate and data signals for image display, based on the frame data stored in the buffer 238.

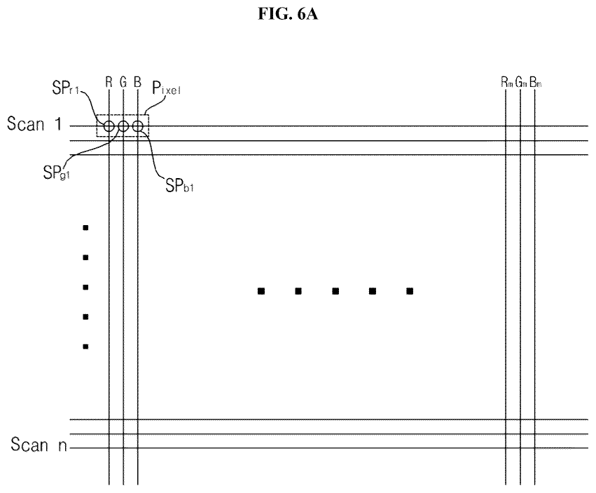

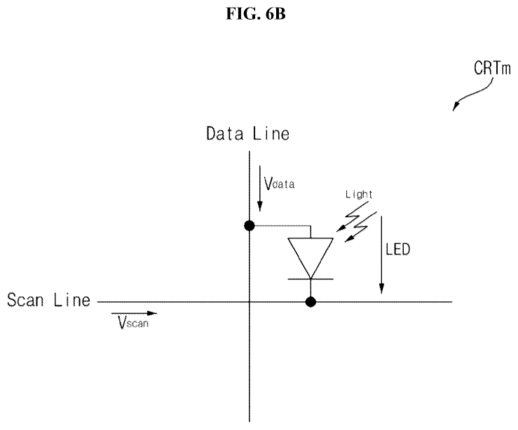

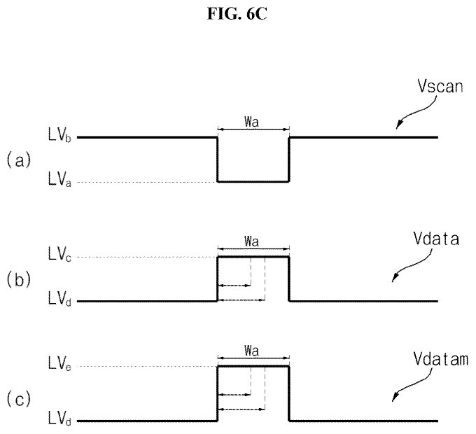

FIGS. 6A to 6C are diagrams referred to in the description of the light-emitting panel of FIG. 5.

First, FIG. 6A is a diagram illustrating a pixel in the light-emitting panel 210.

Referring to the figure, the light-emitting panel 210 may include a plurality of scan lines Scan1 to Scann and a plurality of data lines R1, G1, and B1 to Rm, Gm, and Bm intersecting the scan lines.

Meanwhile, a pixel (subpixel) is defined in an intersecting area of the scan line and the data line in the light-emitting panel 210. In the figure, a pixel including sub-pixels SR1, SG1, and SW1 of RGB is shown.

Meanwhile, a red light-emitting diode, a green light-emitting diode, and a blue light-emitting diode are disposed at the subpixels SR1, SG1, and SB1 of RGB, respectively.

FIG. 6B illustrates a circuit of any one sub-pixel in the pixel of the light-emitting panel of FIG. 6A.

Referring to the figure, a light-emitting subpixel circuit CRTm may be a passive type, which may have a light-emitting diode LED alone but no switching element.

As shown in the figure, an anode of the light-emitting diode LED may be connected to a data line, thereby allowing for input of a data signal Vdata, and a cathode of the light-emitting diode LED may be connected to a scan line, thereby allowing for input of a scan signal Vscan.

Meanwhile, the light-emitting diode may emit light or not during a plurality of subframes based on passive matrix-type.

FIG. 6C is a diagram showing an example of a scan signal and a data signal.

Referring to the figure, a scan signal Vscan applied to the red light-emitting diode, the green light-emitting diode, and the blue light-emitting diode may maintain an LVb level and then fall to an LVa level at a scan timing.

In this case, the width of the scan signal Vscan may be set to Wa.

Meanwhile, the red light-emitting diode may have higher light emission efficiency than the green light-emitting diode and the blue light-emitting diode because of the device characteristics.

In response to this, the driving controller 285 may be configured to control the level of a data signal supplied to the red light-emitting diode to be lower than the level of a data signal supplied to the green light-emitting diode or the blue light-emitting diode.

(b) of FIG. 6C illustrates a data signal Vdata that maintains an LVd level and then rises to an LVc level at the scan timing of the scan signal Vscan.

(c) of FIG. 6C illustrates a data signal Vdatam that maintains the LVd level and then rises to an LVe level which is higher than the LVc level at the scan timing of the scan signal Vscan.

The data signal Vdata of the LVc level may be applied to the red light-emitting diode, and the data signal Vdatam of the LVe level higher than the LVc level may be applied to the green light-emitting diode or the blue light-emitting diode.

Accordingly, a data signal corresponding to a light-emitting diode may be outputted, and uniform color rendering can be performed.

Meanwhile, the data signal Vdata of (b) of FIG. 6C or the data signal Vdatam of (c) of FIG. 6C are data signals based on pulse width variation, and the luminance of a light-emitting diode changes as the duty cycle changes with the pulse width.

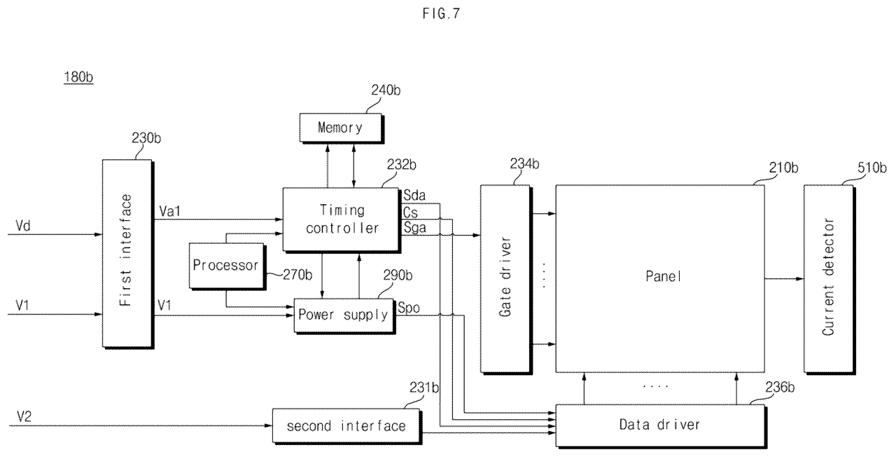

FIG. 7 is an exemplary inner block diagram of the display of FIG. 2.

Referring to the figure, an organic light-emitting panel-based display 180b may include an organic light-emitting panel 210b, a first interface 230b, a second interface 231b, a timing controller 232b, a gate driver 234b, a data driver 236b, a memory 240b, a processor 270b, a power supply 290b, a current detector 510b, and the like.

The display 180b receives an image signal Vdb, a first DC voltage V1b, and a second DC voltage V2b, and may display a certain image based on the image signal Vdb.

Meanwhile, the first interface 230b in the display 180b may receive the image signal Vdb and the first DC voltage V1b from the signal processing device 170.

Here, the first DC voltage V1b may be used for the operation of the power supply 290b and the timing controller 232b in the display 180b.

Next, the second interface 231b may receive a second DC voltage V2b from an external power supply 190b. Meanwhile, the second DC voltage V2b may be input to the data driver 236b in the display 180b.

The timing controller 232b may output a data driving signal Sdab and a gate driving signal Sgab, based on the image signal Vdb.

For example, when the first interface 230b converts the input image signal Vdb and outputs the converted image signal Valb, the timing controller 232b may output the data driving signal Sdab and the gate driving signal Sgab based on the converted image signal Va1b.

The timing controller 232b may further receive a control signal, a vertical synchronization signal Vsyncb, and the like, in addition to the image signal Vdb from the signal processing device 170b.

In addition to the image signal Vdb, based on a control signal, a vertical synchronization signal Vsyncb, and the like, the timing controller 232b generates a gate driving signal Sgab for the operation of the gate driver 234b, and a data driving signal Sdab for the operation of the data driver 236b.

At this time, when the panel 210b includes a RGBW subpixel, the data driving signal Sdab may be a data driving signal for driving of RGBW subpixel.

Meanwhile, the timing controller 232b may further output a control signal Csb to the gate driver 234b.

The gate driver 234b and the data driver 236b supply a scan signal and an image signal to the organic light-emitting panel 210b through a gate line GLb and a data line DLb, respectively, according to the gate driving signal Sgab and the data driving signal Sdab from the timing controller 232b. Accordingly, the organic light-emitting panel 210b displays a certain image.

Meanwhile, the panel 210b may include an organic light emitting layer. In order to display an image, a plurality of gate lines GLb and data lines DLb may be disposed in a matrix form in each pixel corresponding to the organic light emitting layer.

Meanwhile, the data driver 236b may output a data signal to the organic light-emitting panel 210b based on a second DC voltage V2b from the second interface 231b.

The power supply 290b may supply various power supplies to the gate driver 234b, the data driver 236b, the timing controller 232b, and the like.

The current detector 510b may detect the current flowing in a sub-pixel of the panel 210b. The detected current may be input to the processor 270b or the like, for a cumulative current calculation.

The processor 270b may perform each type of control of the display 180b. For example, the processor 270b may be configured to control the gate driver 234b, the data driver 236b, the timing controller 232b, and the like.

Meanwhile, the processor 270b may receive current information flowing in a sub-pixel of the panel 210b from the current detector 510b.

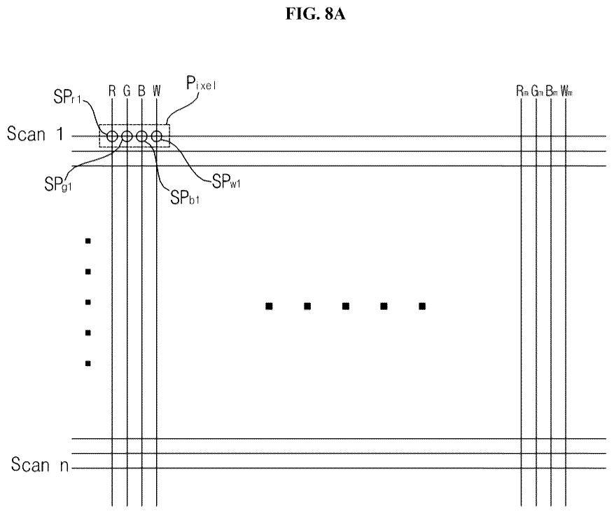

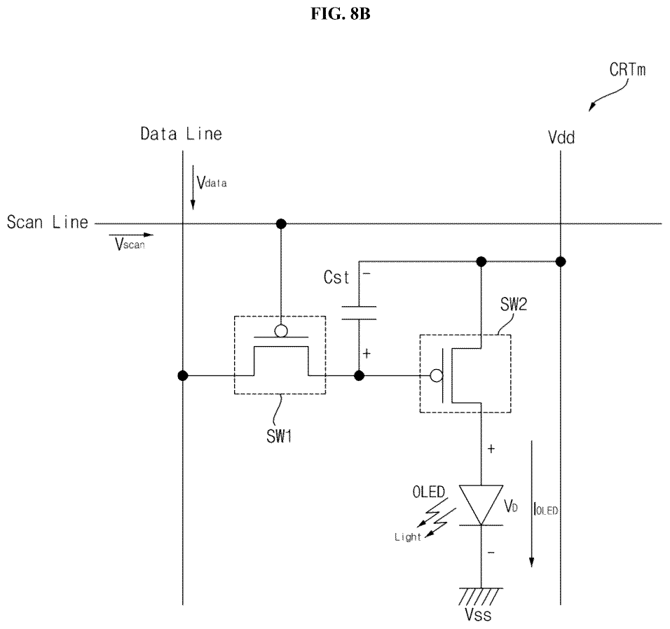

FIGS. 8A and 8B are diagrams referred to in the description of the organic light-emitting panel of FIG. 7.

First, FIG. 8A is a diagram illustrating a pixel in the organic light-emitting panel 210b.

Referring to the figure, the organic light-emitting panel 210b may include a plurality of scan lines Scan1 to Scann and a plurality of data lines R1, G1, B1, W1 to Rm, Gm, Bm, Wm intersecting the scan lines.

Meanwhile, a pixel (subpixel) is defined in an intersecting area of the scan line and the data line in the organic light-emitting panel 210b. In the figure, a pixel including sub-pixels SR1, SG1, SB1, and SW1 of RGBW is shown.

FIG. 8B illustrates a circuit of any one subpixel in the pixel of the organic light-emitting panel of FIG. 8A.

Referring to the figure, an organic light-emitting sub pixel circuit CRTm may include, as an active type, a scan switching element SW1, a storage capacitor Cst, a drive switching element SW2, and an organic light emitting layer OLED.

The scan switching element SW1 is turned on according to the input scan signal Vdscan, as a scan line is connected to a gate terminal. When it is turned on, the input data signal Vdata is transferred to the gate terminal of a drive switching element SW2 or one end of the storage capacitor Cst.

The storage capacitor Cst is formed between the gate terminal and the source terminal of the drive switching element SW2, and stores a certain difference between a data signal level transmitted to one end of the storage capacitor Cst and a DC voltage (VDD) level transmitted to the other terminal of the storage capacitor Cst.

For example, when the data signal has a different level according to a Plume Amplitude Modulation (PAM) method, the power level stored in the storage capacitor Cst changes according to the level difference of the data signal Vdata.

As another example, when the data signal has a different pulse width according to a pulse width modulation (PWM) method, the power level stored in the storage capacitor Cst changes according to the pulse width difference of the data signal Vdata.

The drive switching element SW2 is turned on according to the power level stored in the storage capacitor Cst. When the drive switching element SW2 is turned on, the driving current (IOLED), which is proportional to the stored power level, flows in the organic light emitting layer (OLED). Accordingly, the organic light emitting layer OLED performs a light emitting operation.

The organic light emitting layer OLED may include a light emitting layer (EML) of RGBW corresponding to a subpixel, and may include at least one of a hole injecting layer (HIL), a hole transporting layer (HTL), an electron transporting layer (ETL), and an electron injecting layer (EIL). In addition, it may include a hole blocking layer, and the like.

Meanwhile, the subpixels emit a white light in the organic light emitting layer OLED. However, in the case of green, red, and blue subpixels, a subpixel is provided with a separate color filter for color implementation. That is, in the case of green, red, and blue subpixels, each of the subpixels further includes green, red, and blue color filters. Meanwhile, since a white subpixel outputs a white light, a separate color filter is not required.

Meanwhile, in the figure, it is illustrated that a p-type MOSFET is used for a scan switching element SW1 and a drive switching element SW2, but an n-type MOSFET or other switching element, such as a JFET, IGBT, SIC, or the like are also available.

Meanwhile, the pixel may continuously emit light in the organic light emitting layer (OLED), after a scan signal is applied, during a unit display period, specifically, during a unit frame.

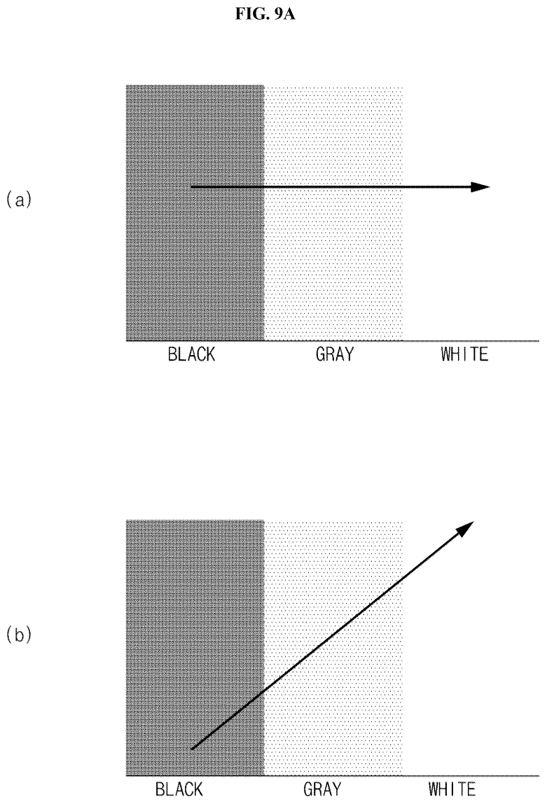

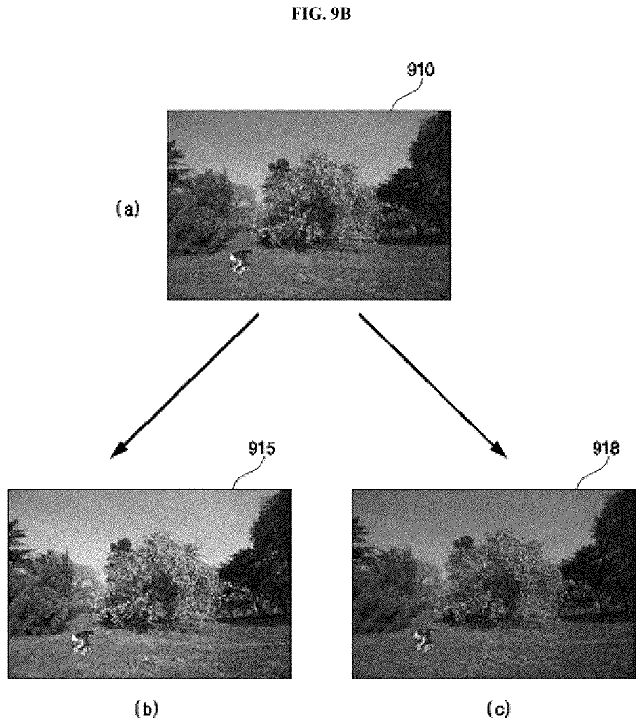

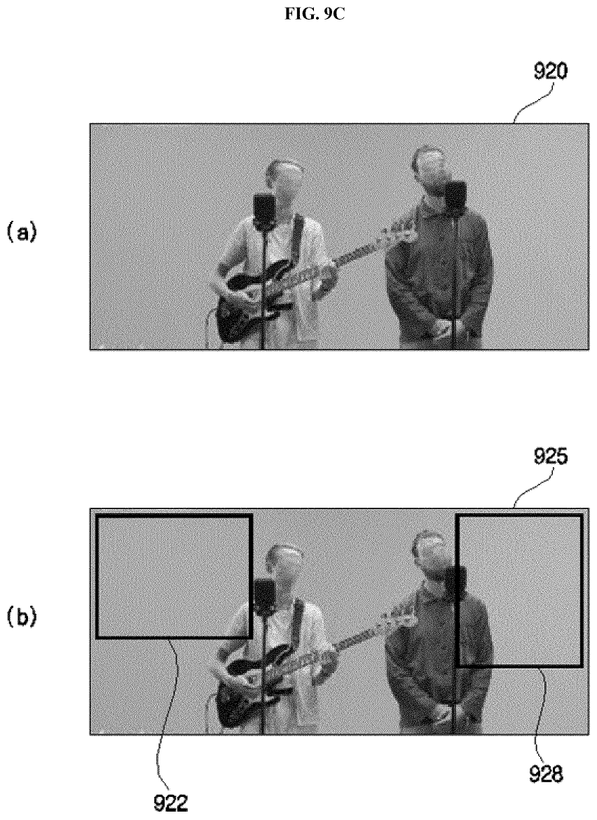

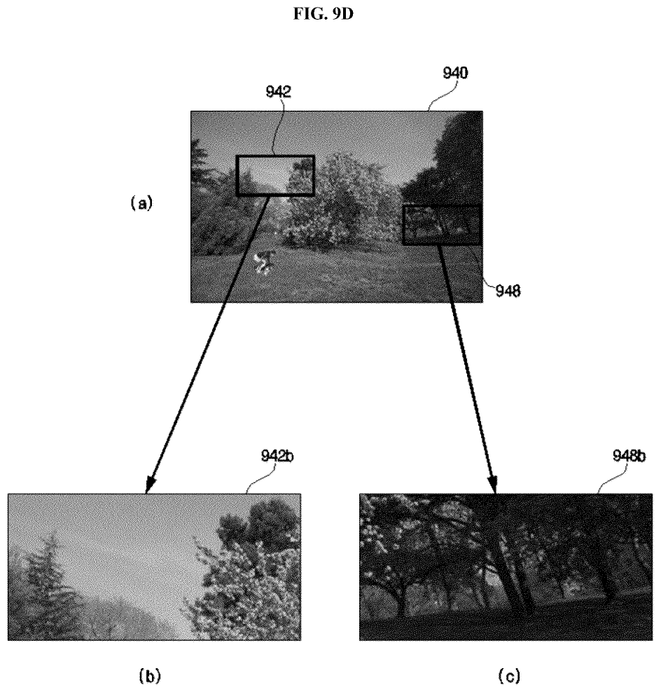

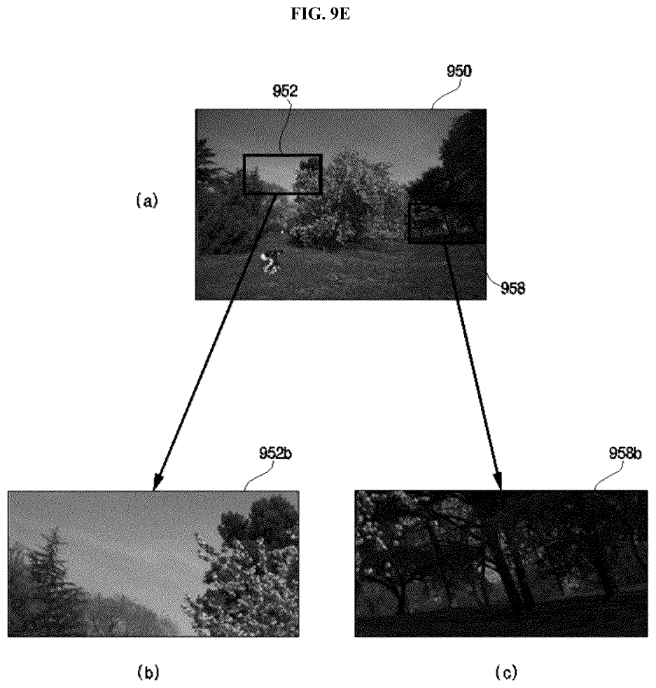

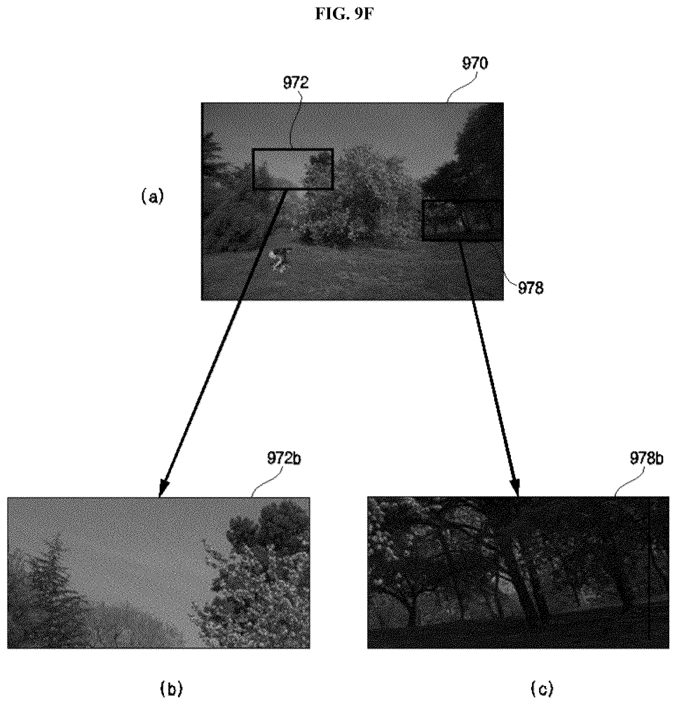

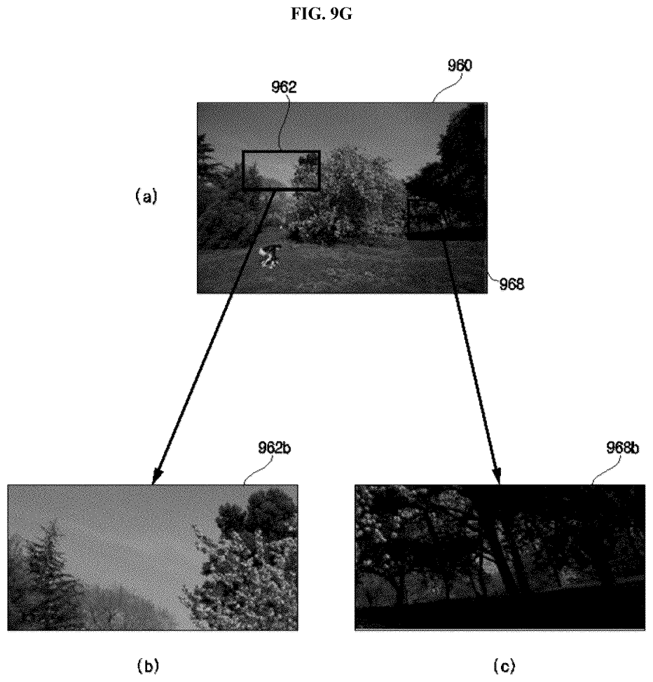

FIGS. 9A to 9G are views referred to in the description of an operation of an image display apparatus related to the present disclosure.

First, FIG. 9A is a diagram illustrating the power consumption of a liquid crystal panel-based image display apparatus and the power consumption of an organic light-emitting panel-based image display apparatus.

Referring to the figure, (a) of FIG. 9A illustrates the power consumption of a liquid crystal panel-based image display apparatus.

For example, in the liquid crystal panel-based image display apparatus, if the luminance of an image increases from black to gray or from gray to white, the level of the power consumption of the liquid crystal panel-based image display apparatus may remain constant without a significant change.

In the figure, the horizontal axis may represent luminance level, and the longitudinal axis may represent power consumption level.

That is, the power consumption level of the liquid crystal panel-based image display apparatus may be approximately constant even if the luminance level increases.

(b) of FIG. 9A is a view illustrating the power consumption of an organic light-emitting panel-based image display apparatus.

For example, in the organic light-emitting panel-based image display apparatus, if the luminance of an image increases from black to gray or from gray to white, the level of the power consumption of the organic light-emitting panel-based image display apparatus may increase.

In the figure, the horizontal axis may represent luminance level, and the longitudinal axis may represent power consumption level.

That is, if the luminance level increases, the power consumption level of the organic light-emitting panel-based image display apparatus may increase in proportion to the luminance level.

Meanwhile, similarly to the organic light-emitting panel-based image display apparatus, the power consumption level of an LED-based image display apparatus may increase in proportion to the luminance level.

That is, the power consumption level of a self-luminous panel-based image display apparatus 100 may increase in proportion to the luminance level.

FIG. 9B illustrates various examples of an output image based on an increase in the contrast ratio of a first input image or a decrease in the luminance thereof.

Referring to the figure, if the contrast ratio of the first input mage 910 of (a) of FIG. 9B is increased, an image 915 with a higher contrast ratio 915 may be outputted, as shown in (b) of FIG. 9B.

However, the power consumption may be increased due to an increase in luminance or brightness although the contrast ratio of the image 915 is increased.

Meanwhile, if the luminance or brightness of the first input image 910 of (a) of FIG. 9B is decreased, an image 918 with a lower luminance or brightness may be outputted as shown in (c) of FIG. 9B.

Accordingly, the power consumption may be reduced, but the picture quality may be degraded due to the decrease in luminance or brightness.

FIG. 9C illustrates an image 925 produced by reducing the power consumption of a second input image based on a histogram.

Referring to the figure, an image 925 with lower power consumption may be outputted by reducing the power consumption of the second input image 920 of (a) of FIG. 9C based on a histogram.

However, artifacts may appear in a background area 922 and 928 except a human figure area due to distortion in grayscale, although the power consumption of the image 925 is reduced. Moreover, the contrast ratio may be lowered.

FIG. 9D illustrates an example of an input image.

Referring to the drawing, the input image 940 may include a first area 942 including the edge of a foreground tree and the sky and a second area 948 including a background tree, as shown in (a) of FIG. 9D.

(b) of FIG. 9D is an enlarged view 942b of the first area 942, and (c) of FIG. 9D is an enlarged view 948b of the second area 948.

FIG. 9E illustrates an example an image produced by reducing the power consumption of the input image of FIG. 9D.

Referring to the figure, the image 950 of (a) of FIG. 9E may be an image produced by reducing the power consumption of the input image 940 of FIG. 9D based on a histogram.

For example, the input image 940 of FIG. 9D may be classified by a luminance histogram, and the power consumption may be reduced based on the classified histogram.

(b) of FIG. 9E is an enlarged view 952b of the first area 952 of the image 950 whose power consumption is reduced based on a histogram, and (c) of FIG. 9E is an enlarged view 958b of the second area 958 of the image 950 whose power consumption is reduced based on a histogram.

According to the image 950 of FIG. 9E, a reduction in power consumption and an improvement in contrast ratio can be achieved but a considerable number of iterations is required.

FIG. 9F illustrates another example of an image produced by reducing the power consumption of the input image of FIG. 9D.

Referring to the figure, the image 970 of (a) of FIG. 9F may be an image produced by reducing the power consumption of the input image 940 of FIG. 9D based on structural similarity.

For example, the input image 940 of FIG. 9D may be classified according to structural similarity in luminance, and the power consumption may be reduced based on the classification.

(b) of FIG. 9F is an enlarged view 962b of the first area 962 of the image 960 whose power consumption is reduced based on structural similarity, and (c) of FIG. 9F is an enlarged view 968b of the second area 968 of the image 960 produced by reducing the power consumption based on structural similarity.

According to the image 960 of FIG. 9F, a reduction in power consumption and an improvement in contrast ratio can be achieved, and amount of calculations needed in a computation process is small. However, there is a disadvantage that saturation occurs at low gray levels.

FIG. 9G illustrates another example of an image produced by reducing the power consumption of the input image of FIG. 9D.

Referring to the figure, an image 970 of (a) of FIG. 9G may be an image produced by reducing the power consumption of the input image 940 of FIG. 9D based on unsupervised machine learning.

For example, the input image 940 of FIG. 9D may be classified based on luminance unsupervised machine learning, and the power consumption may be reduced based on the classification.

(b) of FIG. 9G is an enlarged view 972b of the first area 972 of the image 970 whose power consumption is reduced based on unsupervised machine learning, and (c) of FIG. 9G is an enlarged view 968b of the second area 978 of the image 970 whose power consumption is reduced based on unsupervised machine learning.

According to the image 970 of FIG. 9G, a reduction in power consumption and an improvement in contrast ratio can be achieved, but a considerable amount of calculations is required in a computation process.

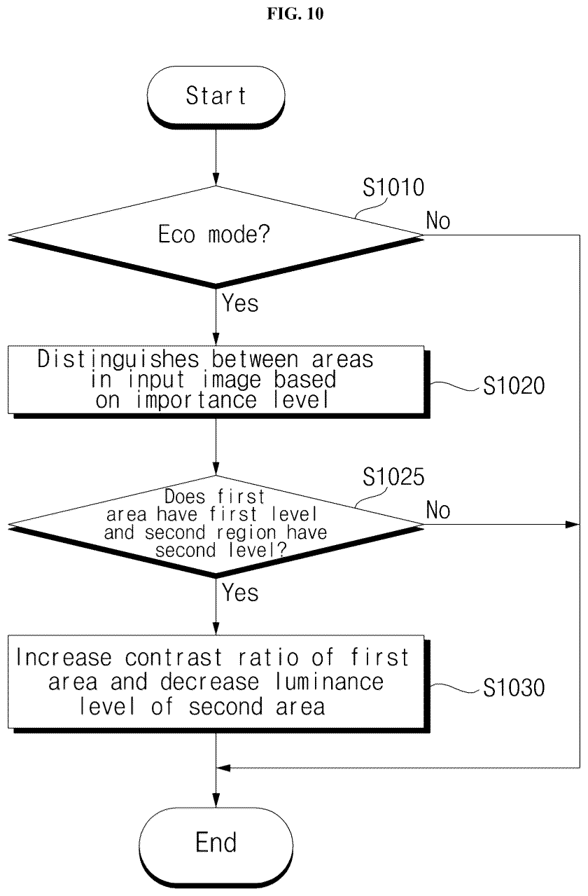

In view of this, the present disclosure proposes a method of improving contrast ratio while reducing power consumption, thereby reducing amount of calculations. Moreover, the present disclosure proposes a method in which saturation does not occur at all gray levels. This will be described with reference to FIG. 10 and the subsequent drawings.

FIG. 10 is a sequential chart showing a method of operating an image display apparatus according to an embodiment of the present disclosure.

Referring to the figure, the signal processing device 170 in the image display apparatus 100 according to an embodiment of the present disclosure may determine whether low power consumption mode or eco mode is turned on (S1010), and, if so, may run low power consumption mode or eco mode.

For example, the signal processing device 170 in the image display apparatus 100 according to an embodiment of the present disclosure may run low power consumption mode or eco modem based on a given input.

As another example, the signal processing device 170 in the image display apparatus 100 according to an embodiment of the present disclosure may run low power consumption mode or eco mode, based on the type of content.

Specifically, the signal processing device 170 in the image display apparatus may run low power consumption mode or eco mode, if the content is a video content for viewing not a type of content for providing information.

As another example, the signal processing device 170 in the image display apparatus 100 according to an embodiment of the present disclosure may run low power consumption mode or eco mode, based on image display time.

Specifically, the signal processing device 170 in the image display apparatus 100 may run low power consumption mode or eco mode if the image display time is longer than a reference time period.

Next, the signal processing device 170 in the image display apparatus 100 separate between areas in an input image, based on importance level according to low power consumption mode or eco mode (S1020).

For example, the signal processing device 170 may calculate importance levels of a plurality of areas in the input image, based on at least one of the segmentation, depth, light field, or prominence in the input image.

Specifically, the neural processor 333 in the signal processing device 170 may perform learning based on at least one of the segmentation, depth, light field, or prominence in the input image, and calculate importance levels of a plurality of areas in the input image based on learning.

As another example, the signal processing device 170 may calculate the level of importance level of a plurality of areas in the input image, based on the temporal and spatial frequencies, optical flow, frame-by-frame calculations, or learning in the input image.

Specifically, the neural processor 333 in the signal processing device 170 may calculate importance levels of a plurality of areas in the input image based on the temporal and spatial frequencies, optical flow, frame-by-frame calculations, or learning in the input image.

Meanwhile, the signal processing device 170 in the image display apparatus 100 may separate between a plurality of areas in the input image based on importance level.

Next, the signal processing device 170 in the image display apparatus 100 determines whether the importance level of a first area in the input image is a first level and whether the importance level of a second area in the input image is a second level lower than the first level (S1025), and if so, may be configured to control the average picture level (APL) of an output image to be lower than the average picture level (APL) of the input image by increasing a contrast ratio of the first area and reducing the luminance level of the second area (S1030).

In this way, the average picture level of the output image is lower than the average picture level (APL) of the input image, thereby improving contrast ratio while reducing power consumption. Particularly, the contrast ratio of the first area can be improved.

Meanwhile, the signal processing device 170 may be configured to change amount of increase in the contrast ratio of the first area or amount of decrease in the luminance of the second area based on a target power consumption level. Accordingly, it is possible to improve contrast ratio while reducing power consumption.

For example, the signal processing device 170 may be configured to, in response to the power consumption level of the input image being higher than the target power consumption level, as the difference between them increases, increase amount of decrease in the luminance of the second area and decrease amount of increase in the contrast ratio of the first area.

As another example, the signal processing device 170 may be configured to, in response to the power consumption level of the input image being higher than the target power consumption level, as the difference between them decreases, decrease amount of decrease in the luminance of the second area and increase amount of increase in the contrast ratio of the first area.

Meanwhile, the signal processing device 170 may be configured to change amount of increase in the contrast ratio of the first area or amount of decrease in the luminance of the second area, based on a proportion of the first area or a proportion of the second area. Accordingly, it is possible to improve contrast ratio while reducing power consumption.

For example, the signal processing device 170 may be configured to, as the proportion of the first area decreases or a proportion of the second area increases, decrease amount of decrease in the luminance of the second area.

As another example, the signal processing device 170 may be configured to, as the proportion of the first area increases or a proportion of the second area decreases, decrease amount of increase in the contrast ratio of the first area.

Meanwhile, in eco mode or in low power consumption mode, the signal processing device 170 may increase the luminance level of the first area. Accordingly, it is possible to improve contrast ratio while reducing power consumption.

Meanwhile, in eco mode or in low power consumption mode, the signal processing device 170 may be configured to control the average picture level of the output image to be lower than the average picture level of the input image by increasing a contrast ratio of the first area and decreasing a luminance level of the second area. Accordingly, it is possible to improve contrast ratio while reducing power consumption.

As a consequence, as shown in FIG. 10, the signal processing device 170 may perform control a contrast ratio of the first area to be a higher than a contrast ratio of the second area, and such that amount of decrease in the luminance of the second area is larger than amount of increase in the luminance of the first area. Accordingly, it is possible to improve contrast ratio while reducing power consumption.

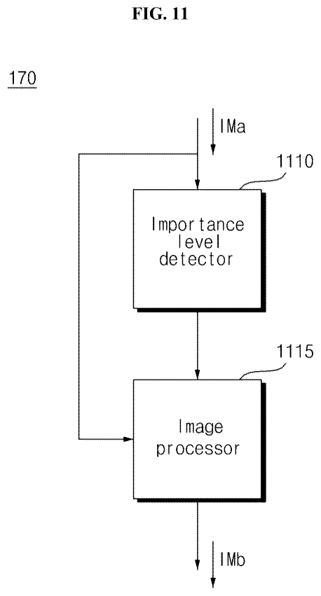

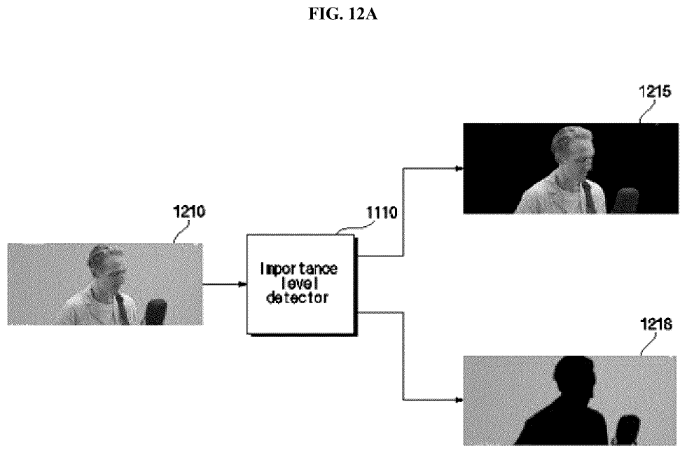

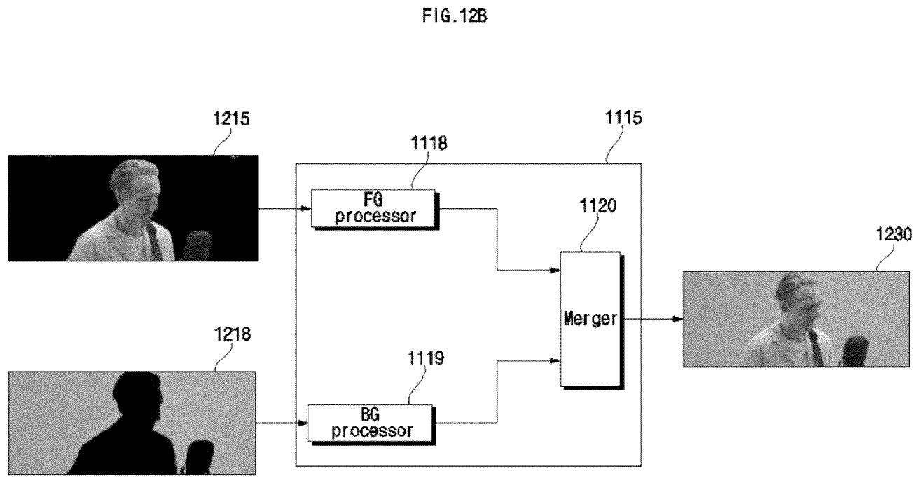

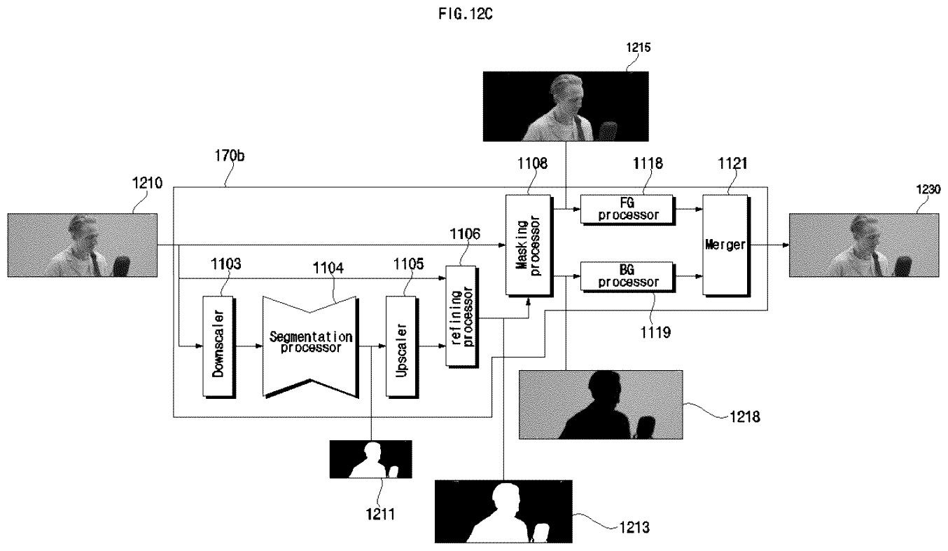

FIG. 11 is an exemplary internal block diagram of a signal processing device according to an embodiment of the present disclosure.

Referring to the figure, the signal processing device 170 according to an embodiment of the present disclosure may include an importance level detector 1110 for detecting the level of importance level of an input image IMa and an image processor 1115 for outputting an output image IMb by performing image processing based on importance level.

Meanwhile, the image processor 1115 in the drawing may correspond to the image processor 320 of FIG. 3.

Meanwhile, the importance level detector 1110 may separate between areas in the input image IMa, based on importance level according to low power consumption mode or eco mode.

For example, the importance level detector 1110 may calculate importance levels of a plurality of areas in the input image IMa, based on at least one of the segmentation, depth, light field, or prominence in the input image IMa.

Specifically, the importance level detector 1110 may perform learning based on at least one of the segmentation, depth, light field, or prominence in the input image IMa, by using the neural processor 333 in the signal processing device 170, and calculate importance levels of a plurality of areas in the input image IMa based on learning.

Meanwhile, the importance level detector 1110 may calculate a parameter on the segmentation, depth, light field, or prominence in the input image IMa, in which case the calculations may be done not based on iterations but based on individual operations.

As another example, the importance level detector 1110 may calculate importance levels of a plurality of areas in the input image IMa, based on the temporal and spatial frequencies, optical flow, frame-by-frame calculations, or learning in the input image IMa.

Specifically, the importance level detector 1110 may calculate importance levels of a plurality of areas in the input image IMa based on the temporal and spatial frequencies, optical flow, frame-by-frame calculations, or learning in the input image IMa, by using the neural processor 333 in the signal processing device 170.

Meanwhile, the importance level detector 1110 may calculate a contrast ratio parameter and a power consumption reduction parameter for the input image IMa.

In this case, the importance level detector 1110 may calculate a contrast ratio parameter and a power consumption reduction parameter for the input image IMa, not based on iterations but based on individual operations.

Meanwhile, the importance level detector 1110 in the signal processing device 170 may be configured to analyze a histogram of the input image IMa, based on a contrast ratio parameter and a power consumption reduction parameter for the input image IMa, and set different power consumption reduction parameters for the same contrast ratio parameter.

Next, if the importance level of a first area in the input image IMa is a first level and the importance level of a second area in the input image IMa is a second level lower than the first level, the image processor 1115 may be configured to control the average picture level (APL) of the output image IMb to be lower than the average picture level (APL) of the input image IMa, by increasing a contrast ratio of the first area and decreasing a luminance level of the second area.

In this way, the average picture level of the output image IMb is lower than the average picture level (APL) of the input image IMa, thereby improving contrast ratio while reducing power consumption. Particularly, the contrast ratio of the first area can be improved.

Meanwhile, the image processor 1115 may be configured to change amount of increase in the contrast ratio of the first area or amount of decrease in the luminance of the second area based on a target power consumption level. Accordingly, it is possible to improve contrast ratio while reducing power consumption.

For example, the image processor 1115 may be configured to, in response to the power consumption level of the input image IMa being higher than the target power consumption level, as the difference between them increases, increase amount of decrease in the luminance of the second area and decrease amount of increase in the contrast ratio of the first area.

As another example, the image processor may be configured to, in response to the power consumption level of the input image IMa being higher than the target power consumption level, as the difference between them decreases, decrease amount of decrease in the luminance of the second area and increase amount of increase in the contrast ratio of the first area.

Meanwhile, the image processor 1115 may be configured to change amount of increase in the contrast ratio of the first area or amount of decrease in the luminance of the second area, based on a proportion of the first area or a proportion of the second area. Accordingly, it is possible to improve contrast ratio while reducing power consumption.

For example, the image processor 115 1115 may be configured to, as the proportion of the first area decreases or a proportion of the second area increases, decrease amount of decrease in the luminance of the second area.

As another example, the image processor 115 1115 may be configured to, as the proportion of the first area increases or a proportion of the second area decreases, decrease amount of increase in the contrast ratio of the first area.

Meanwhile, in eco mode or in low power consumption mode, the image processor 115 may increase the luminance level of the first area. Accordingly, it is possible to improve contrast ratio while reducing power consumption.

Meanwhile, in eco mode or in low power consumption mode, the image processor 115 may be configured to control the average picture level of the output image IMb to be lower than the average picture level of the input image IMa, by increasing a contrast ratio of the first area and decreasing a luminance level of the second area. Accordingly, it is possible to improve contrast ratio while reducing power consumption.

As a consequence, as shown in FIG. 11, the image processor 115 may perform control a contrast ratio of the first area to be a higher than a contrast ratio of the second area, and such that amount of decrease in the luminance of the second area is larger than amount of increase in the luminance of the first area. Accordingly, it is possible to improve contrast ratio while reducing power consumption.

FIGS. 12A to 15B are diagrams referred to in the description of FIG. 10 or FIG. 11.

FIG. 12A is a diagram referred to in the description of an operation of the importance level detector of FIG. 11.

Referring to the figure, the importance level detector 1110 may separate between areas in an input image 1210, based on importance level according to low power consumption mode or eco mode.

For example, the importance level detector 1110 may separate between a foreground area and a background area in the input image 1210, based on importance level according to low power consumption mode or eco mode, and output a foreground image 1215 corresponding to the separated foreground area and a background image 1218 corresponding to the separated background area.

Specifically, the importance level detector 1110 may calculate importance levels of a plurality of areas in the input image 1210, based on at least one of the segmentation, depth, light field, or prominence in the input image 1210.

Also, the importance level detector 110 may separate between a foreground area and a background area in the input image 1210 based on the level of importance level and output a foreground image 1215 corresponding to the separated foreground area and a background image 1218 corresponding to the separated background area.

Meanwhile, the importance level detector 1110 may calculate importance levels of a plurality of areas in the input image 1210, based on the temporal and spatial frequencies, optical flow, frame-by-frame calculations, or learning in the input image 1210, and separate between a foreground area and a background area in the input image 1210 based on the calculated level of importance level.

As another example, the importance level detector 1110 may separate between a far area and a near area in the input image 1210, based on importance level according to low power consumption mode or eco mode, and output a near-distance image corresponding to the separated near area and a far-distance image corresponding to the separated far area.

As yet another example, the importance level detector 1110 may separate between an in-focus area and an out-of-focus area in the input image 1210, based on importance level according to low power consumption mode or eco mode, and output an in-focus image corresponding to the separated in-focus area and an out-of-focus image corresponding to the separated in-focus area.

As a further example, the importance level detector 1110 may separate between a visually prominent area and a visually sunken area in the input image 1210, based on importance level according to low power consumption mode or eco mode, and output a visually prominent image corresponding to the separated visually prominent area and a visually sunken image corresponding to the separated visually sunken area.

FIG. 12B is a diagram referred to in the description of an operation of the image processor of FIG. 11.

Referring to the figure, the image processor 1115 may perform image processing, based on the foreground image 1215 corresponding to the fore ground area in the input image 1210 and the background image 1218 corresponding to the background area.

To this end, the image processor 1115 may include a foreground processor 1118, a background processor 1119, and a merger 1120.

Meanwhile, the foreground processor 1118 in the image processor 1118 may receive the foreground image 1215 corresponding to the foreground area in the input image 1210 and increase the contrast ratio of the foreground image 1215.

For example, the foreground processor 1118 in the image processor 1115 may increase the luminance level of the foreground image 1215. Accordingly, the contrast ratio of the foreground area can be improved while reducing power consumption.

Meanwhile, the foreground processor 1118 in the image processor 1115 may be configured to change amount of increase in the contrast ratio of the foreground area, based on a proportion of the foreground area.

For example, the foreground processor 1118 in the image processor 1115 may be configured to, as the proportion of the foreground area increases, decrease amount of increase in the contrast ratio of the foreground area.

That is, the foreground processor 1118 in the image processor 1115 may be configured to, as the proportion of the foreground area increases, decrease amount of increase in the luminance level of the foreground area.

Meanwhile, the background processor 1119 in the image processor 1115 may receive the background image 1218 corresponding to the background area in the input image 1210 and decrease the luminance level of the background image 1218.

For example, the background processor 1119 in the image processor 1115 may perform control amount of decrease in the luminance level of the background image 1218 is larger than amount of increase in the luminance level of the foreground image 1215. Accordingly, the contrast ratio of the foreground area can be improved while reducing power consumption.

Meanwhile, the background processor 1119 in the image processor 1115 may be configured to change amount of decrease in the luminance of the background area, based on a proportion of the background area.

For example, the background processor 1119 in the image processor 1115 may perform control such that, as the proportion of the second area increase, amount of decrease in the luminance of the second area become smaller. Accordingly, the contrast ratio of the foreground area can be improved while reducing power consumption.

Meanwhile, in eco mode or in low power consumption mode, the merger 1120 in the image processor 1115 may merge a foreground image with a higher contrast ratio and a background image with a lower luminance level to output an output image 1230.

Meanwhile, the merger 1120 in the image processor 1115 may output an output image 1230 whose average picture level is lower than the average picture level of the input image 1210. Accordingly, the contrast ratio of the foreground area can be improved while reducing power consumption.

Referring to FIG. 12B, if the importance level of the foreground area is a first level and the importance level of the background area in the input image 1210 is a second level, the image processor 1115 may be configured to control the average picture level of the output image 1230 to be lower than the average picture level of the input image 1210, by increasing a contrast ratio of the foreground area and decreasing a luminance level of the background area.

In this case, the image processor 1115 may perform control such that, the higher the first level, the higher the contrast ratio of the first area, and decrease the luminance level of the second area as the second level decreases. Accordingly, the contrast ratio of the foreground area can be improved while reducing power consumption.

Meanwhile, if the importance level of the near area is the first level and the importance level of the far area in the input image 1210 is the second level, the image processor 1115 may be configured to control the average picture level of the output image 1230 to be lower than the average picture level of the input image 1210, by increasing a contrast ratio of the near area and decreasing a luminance level of the far area. Accordingly, the contrast ratio of the near area can be improved while reducing power consumption.

Meanwhile, the image processor 1115 may separate between an in-focus area and an out-of-focus area in the input image 1210, and if the importance level of the in-focus area is the first level and the importance level of the out-of-focus area in the input image 1210 is the second level, may be configured to control the average picture level of the output image 1230 to be lower than the average picture level of the input image 1210, by increasing a contrast ratio of the in-focus area and decreasing a luminance level of the out-of-focus area. Accordingly, the contrast ratio of the in-focus area can be improved while reducing power consumption.

Meanwhile, the image processor 1115 may separate between a visually prominent area and a visually sunken area in the input image 1210, and if the importance level of the visually prominent area is the first level and the importance level of the visually sunken area in the input image 1210 is the second level, may be configured to control the average picture level of the output image 1230 to be lower than the average picture level of the input image 1210, by increasing a contrast ratio of the visually prominent area and the decreasing a luminance level of the visually sunken area. Accordingly, the contrast ratio of the visually prominent area can be improved while reducing power consumption.

FIG. 12C is another exemplary internal block diagram of a signal processing device according to an embodiment of the present disclosure.

Referring to the figure, the signal processing device 170b according to the embodiment of the present disclosure may downscale the input image 1210, perform segmentation based on the downscaled input image, separate between a foreground image and a background image based on the segmentation, and increase the contrast ratio of the separated foreground image and decrease the luminance level of the background image.

To this end, the signal processing device 170b according to the embodiment of the present disclosure may include a downscaler 1103 for downscaling the input image 1210 and a segmentation processor 1104 for performing segmentation based on the downscaled input image.

The segmentation processor 1104 may output a segmentation map 1211 by segmentation processing.

Next, the signal processing device 170b according to the embodiment of the present disclosure may further include an upscaler 1105, a refining processor 1106 for performing refinement based on an upscaled image, and a masking processor 1108 for performing masking based on a refined image 1213 and the input image 1210.

Meanwhile, as shown in the drawing, the resolution or size of the refined image 1213 may be preferably larger than the resolution or size of the segmentation map 1211.

Next, the signal processing device 170b according to the embodiment of the present disclosure may further include a foreground processor 1118 for performing processing of a foreground area, based on a masking result from the masking processor 1108, a background processor 1119 for performing processing of a background area, and a merger 1120.

For example, the foreground processor 1118 may increase the contrast ratio or luminance level of the foreground image 1215.

For example, the background processor 1119 may decrease the luminance level of the background image 1218.

Meanwhile, the foreground processor 1118 in the image processor 1115 may receive the foreground image 1215 corresponding to the foreground area in the input image 1210 and increase the contrast ratio of the foreground image 1215.

Meanwhile, in eco mode or in low power consumption mode, the merger 1120 may merge a foreground image with a higher contrast ratio and a background image with a lower luminance level to output an output image 1230.

Meanwhile, the merger 1120 in the image processor 1115 may output an output image 1230 whose average picture level is lower than the average picture level of the input image 1210. Accordingly, the contrast ratio of the foreground area can be improved while reducing power consumption.

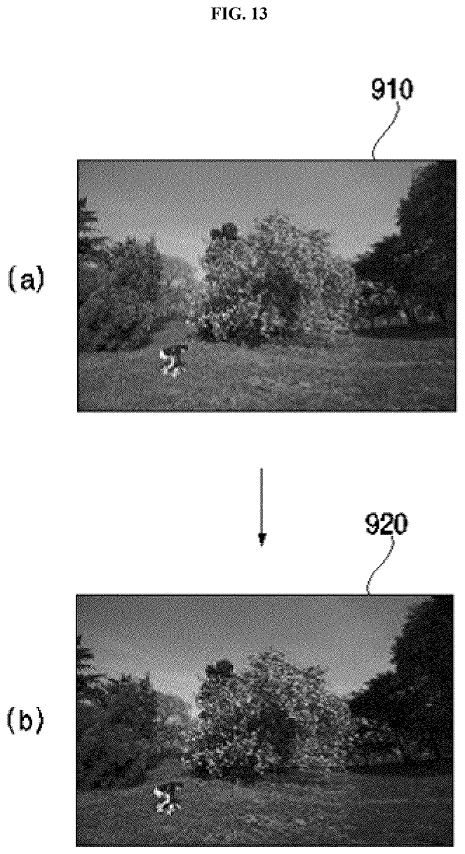

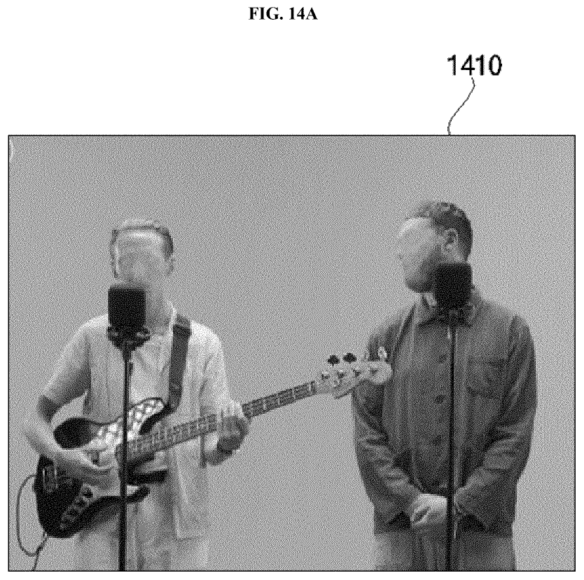

FIG. 13 illustrates an example of an output image based on an increase in the contrast ratio of a first input image and a decrease in the luminance thereof, according to an embodiment of the present disclosure.

Referring to the figure, if the importance level of a first area in the first input image 910 is a first level and the importance level of a second area in the first input image 910 is a second level lower than the first level, the signal processing device 170 according to an embodiment of the present disclosure controls the average picture level of a first output image 920 to be lower than the average picture level of the first input image 910, by increasing a contrast ratio of the first area and decreasing a luminance level of the second area.

For example, if the importance level of a foreground area including a tree area in the first input image 910 is a first level and the importance level of a background area excluding the tree area is a second level lower than the first level, the signal processing device 170 controls the average picture level of the first output image 920 to be lower than the average picture level of the first input image 910, by increasing a contrast ratio of the foreground area and decreasing a luminance level of the background area.

In comparison to FIG. 9B, it is possible to improve contrast ratio while reducing the power consumption of the first output image 920. Notably, it is possible to improve the contrast ratio of the foreground area while reducing the power consumption of the first input image 910.

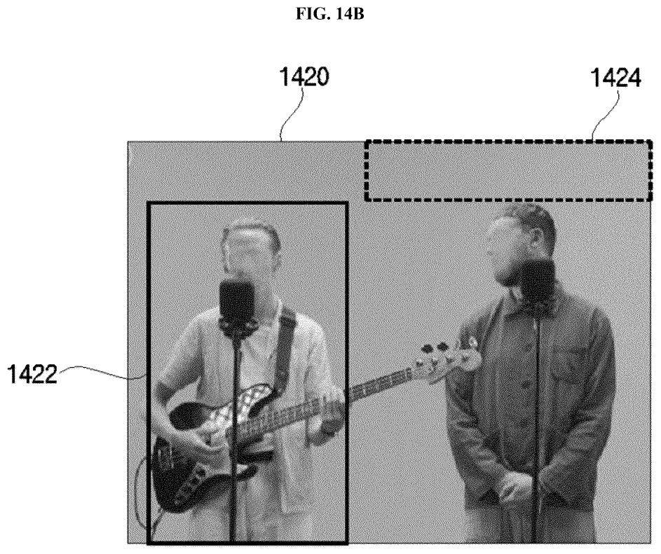

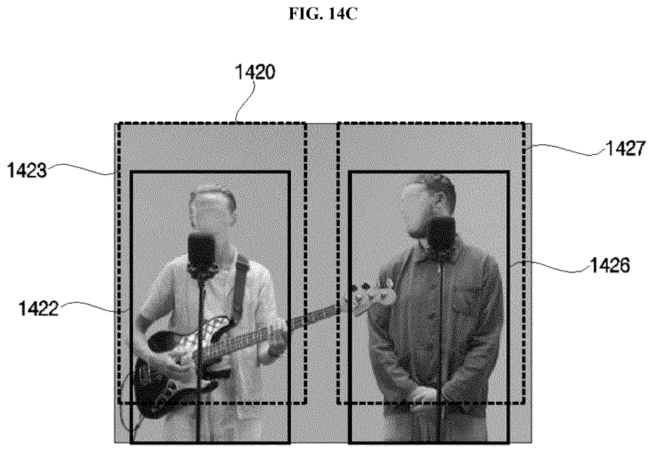

FIGS. 14A to 14C illustrate another example of an output image based on an increase in the contrast ratio of a second input image and a decrease in the luminance thereof, according to an embodiment of the present disclosure.

FIG. 14A illustrates an example of the second input image 1410.

Referring to the figure, the second input image 1410 may include a human figure area corresponding to a foreground area.

If the importance level of a first area in the second input image 1410 is a first level and the importance level of a second area in the second input image 1410 is a second level lower than the first level, the signal processing device 170 according to an embodiment of the present disclosure controls the average picture level of a second output image 1420 to be lower than the average picture level of the second input image 1410, by increasing a contrast ratio of the first area and decreasing a luminance level of the second area. This will be described with reference to FIGS. 14B and 14C.

FIGS. 14B and 14C illustrate an output image based on an increase in the contrast ratio of a second input image and a decrease in the luminance thereof, according to an embodiment of the present disclosure.

First, the contrast ratio of a foreground area 1422 in the second output image 1420 of FIG. 14B may be increased compared to the second input image 1410 of FIG. 14A.

On the other hand, the luminance level of a background area 1424 in the second output image 1420 of FIG. 14B may be decreased compared to the second input image 1410 of FIG. 14A.

As a consequence, the average picture level of the second output image 1420 of FIG. 14B becomes lower than the average picture level of the second input image 1410 of FIG. 14A.

Accordingly, the power consumption of the second output image 1420 can be reduced, and the contrast ratio of the foreground area 1422 can be improved. Furthermore, the luminance level can be decreased without sacrificing the grayscale of the background area 1424.

Meanwhile the signal processing device 170 according to the embodiment of the present disclosure may be configured to decrease amount of decrease in the luminance level of the background area as the color similarity between the foreground area and the background area increases.

Meanwhile, the signal processing device 170 according to the embodiment of the present disclosure may be configured to increase amount of decrease in the luminance level of the background area as the color similarity between the foreground area and the background area decreases.

The second output image 1420 of FIG. 14C may include a first foreground area 1422, a first background area 1423 surrounding the first foreground area 1422, a second foreground area 1426, and a second background area 1427 surrounding the second foreground area 1426.

Meanwhile, the signal processing device 170 may adjust amount of decrease in the luminance of the background area according to the color similarity between the foreground area and the background area.

Meanwhile, if the color similarity between the first foreground area 1422 and the first background area 1423 is higher than the color similarity between the second foreground area 1426 and the second background area 1427, the signal processing device 170 may perform control amount of decrease in the luminance of the first background area 1423 is smaller than amount of decrease in the luminance of the second background area 1427.

Accordingly, the contrast ratio between the first foreground area 1422 and the first background area 1423 can be adaptively adjusted.

Meanwhile, if the color similarity between the second foreground area 1426 and the second background area 1427 is higher than the color similarity between the first foreground area 1422 and the first background area 1423, the signal processing device 170 may perform control amount of decrease in the luminance of the second background area 1427 is smaller than amount of decrease in the luminance of the first background area 1423. Accordingly, the contrast ratio between the second foreground area 1426 and the second background area 1427 can be adaptively adjusted.

Meanwhile, if the color similarity between the second foreground area 1426 and the second background area 1427 is higher than the color similarity between the first foreground area 1422 and the first background area 1423, the signal processing device 170 may perform control such that the saturation and colors of the second background area 1427 are maintained. Accordingly, the contrast ratio between the second foreground area 1426 and the second background area 1427 can be improved.

Meanwhile, if the color similarity between the first foreground area 1422 and the first background area 1423 is higher than the color similarity between the second foreground area 1426 and the second background area 1427, the signal processing device 170 may perform control such that the luminance level of the first foreground area 1422 is maintained or amount of decrease in the luminance level is decreased. Accordingly, the contrast ratio of the first foreground area 1422 can be improved.

Meanwhile, if a plurality of objects is included in the foreground in an image, the signal processing device 170 may apply a different contrast ratio for each object. Accordingly, the contrast ratio can be adaptively adjusted for each object.

Meanwhile, if a plurality of objects is included in the foreground in an image, the signal processing device 170 may reduce the luminance level differently for each background area surrounding each object. Accordingly, amount of decrease in luminance level can be adaptively adjusted for each background area surrounding each object.

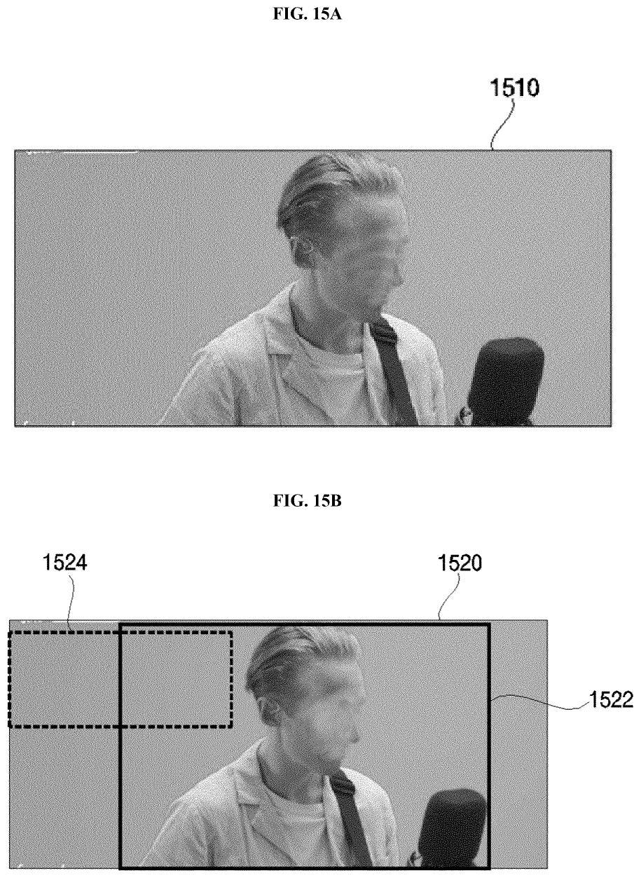

FIGS. 15B and 15C illustrate an example of an output image based on an increase in the contrast ratio of a third input image and a decrease in the luminance thereof, according to an embodiment of the present disclosure.

FIG. 15A illustrates a third input image 1510.

Referring to the figure, the third input image 1510 may include a human figure area corresponding to a foreground area.

If the importance level of a first area in the third input image 1510 is a first level and the importance level of a second area in the third input image 1510 is a second level lower than the first level, the signal processing device 170 according to an embodiment of the present disclosure controls the average picture level of a third output image 1520 to be lower than the average picture level of the third input image 1510, by increasing a contrast ratio of the first area and decreasing a luminance level of the second area.

FIG. 15B illustrates an output image based on an increase in the contrast ratio of a third input image and a decrease in the luminance thereof, according to an embodiment of the present disclosure.

Referring to the figure, the contrast ratio of a foreground area 1522 in the third output image 1520 of FIG. 15B may be increased compared to the third input image 1510 of FIG. 15A.

On the other hand, the luminance level of a background area 1524 in the third output image 1520 of FIG. 15B may be decreased compared to the third input image 1510 of FIG. 15A.

As a consequence, the average picture level of the third output image 1520 of FIG. 15B becomes lower than the average picture level of the third input image 1510 of FIG. 15A.

Accordingly, the power consumption of the third output image 1520 can be reduced, and the contrast ratio of the foreground area 1522 can be improved. Furthermore, the luminance level can be decreased without sacrificing the grayscale of the background area 1524.

Meanwhile, the signal processing device 170 may perform control such that the colors in the foreground area 1522 are maintained.

Meanwhile, the signal processing device 170 may adjust the contrast ratio of an area in the foreground area 1522 according to importance level.

For example, the signal processing device 170 may be configured to, the higher the importance level of an area in the foreground area 1522, the higher the contrast ratio of the area.

Specifically, the signal processing device 170 may perform control such that a face area of higher importance level in the foreground area 1522 has a higher contrast ratio than a clothing area. Accordingly, the contrast ratio can be adaptively improved according to importance level.

Meanwhile, the signal processing device 170 may adjust the contrast ratio according to the colors or saturation in the foreground area 1522.

For example, the signal processing device 170 may adjust the contrast ratios of achromatic and chromatic areas in the foreground area 1522.

Specifically, the signal processing device 170 may perform control such that a chromatic area in the foreground area 1522 has a higher contrast ratio than an achromatic area. Accordingly, the contrast ratio can be adaptively improved according to colors or saturation.

Meanwhile, referring to FIG. 15B, the signal processing device 170 according to another embodiment of the present disclosure controls the average picture level of the output image 1520 to be lower than the average picture level of the input image 1510, separate between a plurality of areas 1522 and 1524 in the input image 1510 based on importance level, and if the importance level of the first area 1522 in the input image 1510 is equal to or higher than a first level, increase the contrast ratio of the first area 1522. Accordingly, it is possible to improve contrast ratio while reducing power consumption. Notably, the contrast ratio of the first area can be improved while reducing the power consumption of the input image.

As described above, an image display apparatus according to an embodiment of the present disclosure comprises: a display; a signal processing device configured to perform signal processing of an input image and output an image signal corresponding to an output image to the display, wherein, in response to an importance level of a first area in the input image being a first level and an importance level of a second area in the input image being a second level lower than the first level, the signal processing device is configured to control the average picture level of the output image to be lower than the average picture level of the input image by increasing a contrast ratio of the first area and decreasing a luminance level of the second area. Accordingly, it is possible to improve contrast ratio while reducing power consumption. Notably, it is possible to improve the contrast ratio of the first area while reducing the power consumption of the input image. Furthermore, it is possible to improve contrast ratio while reducing power consumption based on efficient computation.

The signal processing device may be configured to change amount of increase in the contrast ratio of the first area or amount of decrease in the luminance of the second area based on a target power consumption level. Accordingly, it is possible to improve contrast ratio while reducing power consumption.

The signal processing device may be configured to change amount of increase in the contrast ratio of the first area or amount of decrease in the luminance of the second area, based on a proportion of the first area or a proportion of the second area. Accordingly, it is possible to improve contrast ratio while reducing power consumption.

The signal processing device may be configured to increase the luminance level of the first area. Accordingly, it is possible to improve contrast ratio while reducing power consumption.

In eco mode or in low power consumption mode, the signal processing device may be configured to control the average picture level of the output image to be lower than the average picture level of the input image, by increasing a contrast ratio of the first area and decreasing a luminance level of the second area.

The signal processing device may be configured to control a contrast ratio of the first area to be a higher than a contrast ratio of the second area, and amount of decrease in the luminance of the second area to be greater than amount of decrease in the luminance of the first area. Accordingly, it is possible to improve contrast ratio while reducing power consumption.

The signal processing device may be configured to calculate importance levels of a plurality of areas in the input image, based on at least one of the segmentation, depth, light field, or prominence in the input image. Accordingly, it is possible to improve contrast ratio while reducing power consumption.

The signal processing device may be configured to calculate importance levels of a plurality of areas in the input image based on the temporal and spatial frequency, optical flow, frame-based calculation, or learning in the input image. Accordingly, it is possible to improve the contrast ratio of each of the plurality of areas while reducing power consumption.

The signal processing device may be configured to analyze a histogram of the input image, based on a contrast ratio parameter and a power consumption reduction parameter for the input image, and set different power consumption reduction parameters for the same contrast ratio parameter. Accordingly, it is possible to improve contrast ratio while reducing power consumption.

The signal processing device may be configured to separate between a foreground area and a background area in the input image, and in response to the importance level of the foreground area being the first level and the importance level of the background area in the input image being the second level, control the average picture level of the output image to be lower than the average picture level of the input image by increasing a contrast ratio of the foreground area and decreasing a luminance level of the background area. Accordingly, it is possible to improve the contrast ratio of the foreground area while reducing power consumption.

The signal processing device may be configured to control amount of decrease in the luminance of the foreground area whose level of importance level in the input image is higher to be lower than amount of decrease in the luminance of the background area. Accordingly, it is possible to improve the contrast ratio of the foreground area while reducing power consumption.

The signal processing device may be configured to change amount of increase in the contrast ratio of the foreground area or amount of decrease in the luminance of the background area, based on a proportion of the foreground area or a proportion of the background area. Accordingly, it is possible to improve the contrast ratio of the foreground area while reducing power consumption.

The signal processing device may be configured to increase the luminance level of the foreground area. Accordingly, it is possible to improve the contrast ratio of the foreground area while reducing power consumption.

In eco mode or in low power consumption mode, the signal processing device may be configured to control the average picture level of the output image to be lower than the average picture level of the input image, by increasing a contrast ratio of the foreground area and decreasing a luminance level of the background area. Accordingly, it is possible to improve the contrast ratio of the foreground area while reducing power consumption.

The signal processing device may be configured to separate between a far area and a near area in the input image, and in response to the importance level of the near area being the first level and the importance level of the far area in the input image being the second level, control the average picture level of the output image to be lower than the average picture level of the input image by increasing a contrast ratio of the near area and decreasing a luminance level of the far area. Accordingly, it is possible to improve the contrast ratio of the near area while reducing power consumption.

The signal processing device may be configured to separate between an in-focus area and an out-of-focus area in the input image, and in response to the importance level of the in-focus area being the first level and the importance level of the out-of-focus area in the input image being the second level, control the average picture level of the output image to be lower than the average picture level of the input image by increasing a contrast ratio of the in-focus area and decreasing a luminance level of the out-of-focus area. Accordingly, it is possible to improve the contrast ratio of the in-focus area while reducing power consumption.

The signal processing device may be configured to separate between a visually prominent area and a visually sunken area in the input image, and in response to the importance level of the visually prominent area being a first level and the importance level of the visually sunken area in the input image being a second level, may be configured to control the average picture level of the output image to be lower than the average picture level of the input image, by increasing a contrast ratio of the visually prominent area and the decreasing a luminance level of the visually sunken area. Accordingly, it is possible to improve the contrast ratio of the visually sunken area while reducing power consumption.

The signal processing device may be configured to increase the contrast ratio of the first area as the first level increases, and decrease the luminance level of the second area as the second level decreases. Accordingly, it is possible to improve the contrast ratio of the first area while reducing power consumption.

The signal processing device may be configured to downscale the input image, perform segmentation based on the downscaled input image, separate between a foreground image and a background image based on the segmentation, and increase the contrast ratio of the separated foreground image and decrease the luminance level of the background image. Accordingly, it is possible to improve contrast ratio while reducing power consumption.

Another exemplary embodiment of the present disclosure provides an image display apparatus comprising: a display; a signal processing device configured to perform signal processing of an input image and output an image signal corresponding to an output image to the display, wherein the signal processing device is configured to control the average picture level of the output image to be lower than the average picture level of the input image, separate between a plurality of areas in the input image based on importance level, and in response to the importance level of a first area in the input image being a first level, increase the contrast ratio of the first area. Accordingly, it is possible to improve contrast ratio while reducing power consumption. Notably, it is possible to improve the contrast ratio of the first area while reducing the power consumption of the input image. Furthermore, it is possible to improve contrast ratio while reducing power consumption based on efficient computation.

In response to the importance level of a second area in the input image being a second level lower than the first level, the signal processing device is configured to decrease the luminance level of the second area. Accordingly, it is possible to improve the contrast ratio of the first area while reducing power consumption.

The signal processing device may be configured to calculate importance levels of a plurality of areas in the input image, based on at least one of the segmentation, depth, light field, or prominence in the input image. Accordingly, it is possible to improve the contrast ratio of each of the plurality of areas while reducing power consumption.

While the disclosure has been described with reference to the embodiments, the disclosure is not limited to the above-described specific embodiments, and it will be understood by those skilled in the related art that various modifications and variations may be made without departing from the scope of the disclosure as defined by the appended claims, as well as these modifications and variations should not be understood separately from the technical spirit and prospect of the disclosure.

What is claimed is:

1. An image display apparatus comprising:
a display;
a signal processing device configured to perform signal processing of an input image and output an image signal corresponding to an output image to the display,
wherein, in response to an importance level of a first area in the input image being a first level and an importance level of a second area in the input image being a second level lower than the first level, the signal processing device is configured to control the average picture level of the output image to be lower than the average picture level of the input image by increasing a contrast ratio of the first area and decreasing a luminance level of the second area.

2. The image display apparatus of claim 1, wherein the signal processing device is configured to change amount of increase in the contrast ratio of the first area or amount of decrease in the luminance of the second area based on a target power consumption level.

3. The image display apparatus of claim 1, wherein the signal processing device is configured to change amount of increase in the contrast ratio of the first area or amount of decrease in the luminance of the second area, based on a proportion of the first area or a proportion of the second area.

4. The image display apparatus of claim 1, wherein, in eco mode or in low power consumption mode, the signal processing device is configured to control the average picture level of the output image to be lower than the average picture level of the input image, by increasing a contrast ratio of the first area and decreasing a luminance level of the second area.

5. The image display apparatus of claim 1, wherein the signal processing device is configured to control a contrast ratio of the first area to be a higher than a contrast ratio of the second area, and amount of decrease in the luminance of the second area to be greater than amount of decrease in the luminance of the first area.

6. The image display apparatus of claim 1, wherein the signal processing device is configured to calculate importance levels of a plurality of areas in the input image, based on at least one of the segmentation, depth, light field, or prominence in the input image.

7. The image display apparatus of claim 1, wherein the signal processing device is configured to separate between a foreground area and a background area in the input image, and in response to the importance level of the foreground area being the first level and the importance level of the background area in the input image being the second level, control the average picture level of the output image to be lower than the average picture level of the input image by increasing a contrast ratio of the foreground area and decreasing a luminance level of the background area.

8. The image display apparatus of claim 7, wherein the signal processing device is configured to control amount of decrease in the luminance of the foreground area to be lower than amount of decrease in the luminance of the background area, wherein an importance level of the foreground area is higher than an importance level of the background area.

9. The image display apparatus of claim 7, wherein the signal processing device is configured to change amount of increase in the contrast ratio of the foreground area or amount of decrease in the luminance of the background area, based on a proportion of the foreground area or a proportion of the background area.

10. The image display apparatus of claim 7, wherein the signal processing device is configured to increase the luminance level of the foreground area.

11. The image display apparatus of claim 7, wherein, in eco mode or in low power consumption mode, the signal processing device is configured to control the average picture level of the output image to be lower than the average picture level of the input image, by increasing a contrast ratio of the foreground area and decreasing a luminance level of the background area.

12. The image display apparatus of claim 1, wherein the signal processing device is configured to separate between a far area and a near area in the input image, and in response to the importance level of the near area being the first level and the importance level of the far area in the input image being the second level, control the average picture level of the output image to be lower than the average picture level of the input image by increasing a contrast ratio of the near area and decreasing a luminance level of the far area.

13. The image display apparatus of claim 1, wherein the signal processing device is configured to separate between an in-focus area and an out-of-focus area in the input image, and in response to the importance level of the in-focus area being the first level and the importance level of the out-of-focus area in the input image being the second level, control the average picture level of the output image to be lower than the average picture level of the input image by increasing a contrast ratio of the in-focus area and decreasing a luminance level of the out-of-focus area.

14. The image display apparatus of claim 1, wherein the signal processing device is configured to control such that, the higher the first level, the higher the contrast ratio of the first area, and decrease the luminance level of the second area as the second level decreases.

15. The image display apparatus of claim 1, wherein the signal processing device is configured to downscale the input image, performs segmentation based on the downscaled input image, separate between a foreground image and a background image based on the segmentation, and increase the contrast ratio of the separated foreground image and decrease the luminance level of the background image.

16. An image display apparatus comprising:
a display;
a signal processing device configured to perform signal processing of an input image and output an image signal corresponding to an output image to the display,
wherein the signal processing device is configured to control the average picture level of the output image to be lower than the average picture level of the input image, separate between a plurality of areas in the input image based on importance level, and in response to the importance level of a first area in the input image being a first level, increase the contrast ratio of the first area.

17. The image display apparatus of claim 16, wherein, in response to the importance level of a second area in the input image being a second level lower than the first level, the signal processing device is configured to decrease the luminance level of the second area.

18. The image display apparatus of claim 16, wherein the signal processing device is configured to calculate importance levels of a plurality of areas in the input image, based on at least one of the segmentation, depth, light field, or prominence in the input image.
